(19) United States
(12) Patent Application Publication
(10) Pub. No.: US 2026/0282123 A1
(43) Pub. Date: Sep. 17, 2026

(54) METHODS AND APPARATUSES FOR EXECUTING CONDITIONAL CELL ADDITION AND/OR CHANGE WITH SELECTIVE ACTIVATION OF CELL GROUPS

(71) Applicant: SHARP KABUSHIKI KAISHA, Sakai City, Osaka (JP)

(72) Inventors: He-Hsuan Liu, Taipei (TW); MEI-JU SHIH, Taipei (TW)

(21) Appl. No.: 19/479,923

(22) PCT Filed: May 10, 2024
(86) PCT No.: PCT/CN2024/092314

§ 371 Date: Oct. 29, 2025

Related U.S. Application Data
(60) Provisional application No. 63/466,024, filed on May 12, 2023.
(60) Provisional application No. 63/466,030, filed on May 12, 2023.

(51) Int. Cl. H04W 76/10; H04W 36/36

(52) U.S. Cl. CPC H04W 76/10; H04W 36/362

(57) ABSTRACT

Methods and apparatuses for executing a Conditional Primary Secondary Cell (PSCell) Addition and/or Change with a Selective Activation are provided. The method includes transmitting a Radio Resource Control (RRC) reconfiguration message to a UE, the RRC reconfiguration message including a first candidate configuration; receiving an RRC reconfiguration complete message from the UE; and retaining the first candidate configuration in response to receiving the RRC reconfiguration complete message from the UE. The first candidate configuration includes a first indication that indicates the first candidate configuration as a candidate configuration of the Conditional PSCell Addition with the Selective Activation (CPASA) or a candidate configuration of the Conditional PSCell Change with the Selective Activation (CPCSA), a first candidate target PSCell identity, a first candidate target PSCell identity, at most two first execution conditions, and one or more first conditional configurations associated with the at most two first execution conditions.

### CROSS-REFERENCE TO RELATED APPLICATION(S)

The present disclosure claims the benefit of and priority to U.S. Provisional Patent Application Ser. No. 63/466,024, filed on May 12, 2023, entitled “METHOD AND APPARATUS FOR CONDITIONAL PSCELL ADDITION AND/OR CHANGE WITH SELECTIVE ACTIVATION OF CELL GROUPS,” and U.S. Provisional Patent Application Ser. No. 63/466,030, filed on May 12, 2023, entitled “METHOD AND APPARATUS FOR COUNTER-BASED SELECTIVE ACTIVATION OF CELL GROUPS,” the content of which is hereby incorporated herein fully by reference into the present disclosure for all purposes.

### FIELD

The present disclosure is related to wireless communication and, more specifically, to methods and apparatuses for executing a conditional cell addition and/or change with a selective activation of cell groups.

### BACKGROUND

Various efforts have been made to improve different aspects of wireless communication for cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the art.

### SUMMARY

The present disclosure is related to methods and apparatuses for executing a conditional cell addition and/or change with a selective activation of cell groups.

According to a first aspect of the present disclosure, a method performed by a Base Station (BS) for executing a Conditional Primary Secondary Cell (PSCell) Addition and/or Change with a Selective Activation with a User Equipment (UE) is provided. The method includes transmitting a Radio Resource Control (RRC) reconfiguration message to the UE, the RRC reconfiguration message including a first candidate configuration; receiving an RRC reconfiguration complete message from the UE; and retaining the first candidate configuration in response to receiving the RRC reconfiguration complete message from the UE, where the first candidate configuration includes a first indication that indicates the first candidate configuration as a candidate configuration of the Conditional PSCell Addition with the Selective Activation (CPASA) or a candidate configuration of the Conditional PSCell Change with the Selective Activation (CPCSA), a first candidate target PSCell identity, a first candidate target PSCell identity, at most two first execution conditions, and one or more first conditional configurations associated with the at most two first execution conditions.

In some implementations of the first aspect of the present disclosure, the RRC reconfiguration message further includes a second candidate configuration that includes a second candidate target PSCell identity, at most two second execution conditions, and one or more second conditional configurations associated with the at most two second execution conditions, where the second candidate configuration, by not including the first indication, is not designated as the candidate configuration for the CPASA or the CPCSA for the UE.

In some implementations of the first aspect of the present disclosure, the method further includes releasing the second candidate configuration in response to receiving the RRC reconfiguration complete message from the UE.

In some implementations of the first aspect of the present disclosure, the RRC reconfiguration complete message includes a second indication that indicates which of the one or more first conditional configurations the UE has selected to use for executing the CPASA or the CPCSA.

According to a second aspect of the present disclosure, a Base Station (BS) for executing a Conditional Primary Secondary Cell (PSCell) Addition and/or Change with a Selective Activation with a User Equipment (UE) is provided. The BS includes at least one processor and at least one non-transitory computer-readable medium coupled to the at least one processor and storing one or more computer-executable instructions that, when executed by the at least one processor, cause the BS to transmit a Radio Resource Control (RRC) reconfiguration message to the UE, the RRC reconfiguration message including a first candidate configuration; receive an RRC reconfiguration complete message from the UE; and retain the first candidate configuration in response to receiving the RRC reconfiguration complete message from the UE, where the first candidate configuration includes a first indication that indicates the first candidate configuration as a candidate configuration of the Conditional PSCell Addition with the Selective Activation (CPASA) or a candidate configuration of the Conditional PSCell Change with the Selective Activation (CPCSA), a first candidate target PSCell identity, at most two first execution conditions, and one or more first conditional configurations associated with the at most two first execution conditions.

In some implementations of the second aspect of the present disclosure, the RRC reconfiguration message further includes a second candidate configuration that includes a second candidate target PSCell identity, at most two second execution conditions, and one or more second conditional configurations associated with the at most two second execution conditions, where the second candidate configuration, by not including the first indication, is not designated as the candidate configuration for the CPASA or the CPCSA for the UE.

In some implementations of the second aspect of the present disclosure, the one or more computer-executable instructions, when executed by the at least one processor, further cause the BS to release the second candidate configuration in response to receiving the RRC reconfiguration complete message from the UE.

In some implementations of the second aspect of the present disclosure, the RRC reconfiguration complete message includes a second indication that indicates which of the one or more first conditional configurations the UE has selected to use for executing the CPASA or the CPCSA.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart of a method/process for executing a conditional PSCell addition and/or change with a selective activation with a UE, according to an example implementation of the present disclosure.

FIG. 2 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| 5GC | 5G Core |
| ACK | Acknowledgement |
| AN-PDB | Access Network Packet Delay Budget |
| AS | Access Stratum |
| ASN.1 | Abstract Syntax Notation One |
| BFRQ | Beam Failure Recovery Request |
| BS | Base Station |
| BSR | Buffer Status Report |
| BWP | Bandwidth Part |
| C-RNTI | Cell Radio Network Temporary Identifier |
| CA | Carrier Aggregation |
| CAG | Closed Access Group |
| CB | Codebook-Based |
| CG | Configured Grant |
| CJT | Coherent Joint Transmission |
| CN | Core Network |
| CN-PDB | Core Network Packet Delay Budget |
| CORESET | Control Resource Set |
| CPAC | Conditional Primary Secondary Cell Addition and/or |
| | Change |
| CPC | Conditional Primary Secondary Cell Change |
| CPASA | Conditional Primary Secondary Cell Addition with a |
| | Selective Activation |
| CPCSA | Conditional Primary Secondary Cell Change with a |
| | Selective Activation |
| CPA | Conditional Primary Secondary Cell Addition |
| CPE | Customer Premises Equipment |
| CRC | Cyclic Redundancy Check |
| CSI | Channel State Information |
| CSI-RS | Channel State Information Reference Signal |
| CS-RNTI | Configured Scheduling Radio Network Temporary |
| | Identifier |
| CSS | Common Search Space |
| CU | Central Unit |
| DAPS | Dual Active Protocol Stack |
| DC | Dual Connectivity |
| DCI | Downlink Control Information |
| DG | Dynamic Grant |
| DI | Delay Information |
| DL | Downlink |
| DL-SCH | Downlink Shared Channel |
| DMRS | Demodulation Reference Signal |
| DR | Delay Report |
| DRB | Data Radio Bearer |
| DTCH | Dedicated Traffic Channel |
| DU | Distributed Unit |
| ETSI | European Telecommunications Standards Institute |
| E-UTRA | Evolved Universal Terrestrial Radio Access |
| EN-DC | E-UTRA NR Dual Connectivity |
| EPC | Evolved Packet Core |
| eMBB | Enhanced Mobile BroadBand |
| eMTC | Enhanced Machine Type Communication |
| eNB | Evolved Node B |
| FDD | Frequency Division Duplexing |
| FR | Frequency Range |
| FR1 | Frequency Range 1 |
| FR2 | Frequency Range 2 |
| FWA | Fixed Wireless Access |
| GEO | Geostationary Equatorial Orbit |
| gNB | Next Generation Node B |
| GNSS | Global Navigation Satellite System |
| GW | Gateway |
| HARQ | Hybrid Automatic Repeat Request |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| ITU | International Telecommunication Union |
| L1 | Layer 1 |
| L2 | Layer 2 |
| L3 | Layer 3 |
| LAN | Local Area Network |
| LCH | Logical Channel |
| LCID | Logical Channel Identity |
| LEO | Low Earth Orbit |
| LTE | Long Term Evolution |
| MAC | Medium Access Control |
| MAC CE | MAC Control Element |
| MCG | Master Cell Group |
| MCS | Modulation Coding Scheme |
| MIB | Master Information Block |
| MIMO | Multi-Input Multi-Output |
| mMTC | Massive Machine Type Communications |
| MN | Master Node |
| MR-DC | Multi-Radio Access Technology Dual Connectivity |
| MTC | Machine Type Communication |
| NACK | Negative Acknowledgement |
| NAS | Non-Access Stratum |
| NB-IoT | Narrow Band Internet of Things |
| NCB | Non-Codebook-Based |
| NDI | New Data Indicator |
| NE-DC | NR-E-UTRA Dual Connectivity |
| NGEN-DC | NG-RAN E-UTRA-NR Dual Connectivity |
| NR | New Radio |
| NR-DC | New Radio-Dual Connectivity |
| NR-U | NR Unlicensed |
| NTN | Non-Terrestrial Network |
| PBCH | Physical Broadcast Channel |
| PCell | Primary Cell |
| PCI | Physical Cell Identity |
| PDB | Packet Delay Budget |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical |
| PLMN | Public Land Mobile Network |
| PNI-NPN | Public Network Integrated Non-Public Network |
| PRACH | Physical Random Access Channel |
| PSCell | Primary Secondary Cell Group Cell |
| PSDB | PDU Set Delay Budget |
| PUCCH | Physical Uplink Control Channel |
| PUSCH | Physical Uplink Shared Channel |
| QCL | Quasi-CoLocation |
| QoS | Quality of Service |
| RA | Random Access |
| RACH | Random Access Channel |
| RAN | Radio Access Network |
| RAR | Random Access Response |
| RAT | Radio Access Technology |
| Rel-15 | Release 15 |
| RF | Radio Frequency |
| RLC | Radio Link Control |
| RS | Reference Signal |
| RLF | Radio Link Failure |
| RSTD | Reference Signal Time Difference Measurement |
| RNTI | Radio Network Temporary Identifier |
| RO | RACH Occasion |
| RRC | Radio Resource Control |
| RS | Reference Signal |
| RSRP | Reference Signal Received Power |
| RSRQ | Reference Signal Receiving Quality |
| RX | Reception |
| SA | Selective Activation |
| SCell | Secondary Cell |
| SCG | Secondary Cell Group |
| SDAP | Service Data Adaptation Protocol |
| SDT | Small Data Transmission |
| SI | System Information |
| SIB | System Information Block |
| SL | Sidelink |
| SLIV | Start and Length Indicator Value |
| SN | Secondary Node |
| SNPN | Stand-alone Non-Public Network |
| SpCell | Special Cell |
| SR | Scheduling Request |
| SRB | Signaling Radio Bearer |
| SRS | Sounding Reference Signal |
| SRI | SRS Resource Indicator |
| SSB | Synchronization Signal Block |
| SUL | Supplementary Uplink |
| TA | Tracking Area |
| TAG | Timing Advance Group |
| TAT | Time Alignment Timer |
| TB | Transport Block |
| TCI | Transmission Configuration Indication |
| TDD | Time Division Duplexing |
| TN | Terrestrial Network |
| TPC | Transmission Power Control |
| TPMI | Transmit Precoder Matrix Indication |
| TRP | Transmission Reception Point |
| TRS | Tracking Reference Signal |
| TS | Technical Specification |
| TTT | Time-to-Trigger |
| TX | Transmission |
| UCI | Uplink Control Information |
| UE | User Equipment |
| UL | Uplink |
| UL-CG | Uplink-Configured Grant |
| UPF | User Plane Function |
| URLLC | Ultra-Reliable and Low-Latency Communications |
| USIM | Universal Subscriber Identity Module |
| USS | UE-specific Search Space |
| V2X | Vehicle-to-Everything |
| VSAT | Very Small Aperture Terminal |
| XnAP | Xn Application Protocol |
| XR | Extended Reality |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the MN, including the SpCell and optionally one or more Secondary Cells (SCells). An SCG may refer to a group of serving cells associated with the SN, including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, or at least one of A and B.

Multiple PLMNs may be operated on the unlicensed spectrum. Multiple PLMNs may share the same unlicensed carrier. The PLMNs may be public or private. Public PLMNs (e.g., provided by operators and/or virtual operators) may provide radio services to public subscribers. Public PLMNs may own licensed spectrum and also support radio access technology on the licensed spectrum. Private PLMNs (e.g., provided by micro-operators, factories, and/or enterprises) may provide radio services to their private users (e.g., employees or machines). In some implementations, public PLMNs may support more deployment scenarios. These scenarios may include carrier aggregation between licensed band NR (e.g., the PCell) and NR-U (e.g., the SCell), dual connectivity between licensed band LTE (e.g., the PCell) and NR-U (e.g., the PSCell), stand-alone NR-U, an NR cell with DL in the unlicensed band and UL in the licensed band, and dual connectivity between licensed band NR (e.g., the PCell) and NR-U (e.g., the PSCell). In some implementations, private PLMNs mainly support, but are not limited to, stand-alone unlicensed radio access technology, such as stand-alone NR-U.

The terms, definitions, and abbreviations included in the present disclosure are either sourced from existing documents (such as those from ETSI, ITU, or other sources) or newly created by experts from the 3GPP whenever there was a need for precise vocabulary.

Examples of some selected terms in the present disclosure are provided as follows.

The terms “network (NW),” “cell,” “camped cell,” “serving cell,” “Base Station (BS),” “gNB,” “eNB” and “ng-eNB” may be used interchangeably. In some implementations, some of these items may refer to the same network entity.

The RAT may include, but is not limited to, NR, LTE, E-UTRA connected to 5GC, LTE connected to 5GC, E-UTRA connected to EPC, and LTE connected to EPC. The mechanisms, methods, approaches described in the present disclosure may be applicable to the UEs operating in the public networks or in the private networks (e.g., NPNs, SNPNs, and/or PNI-NPNs).

The mechanisms, methods, approaches described in the present disclosure may be applicable to the licensed frequency and/or the unlicensed frequency.

System information (SI) may refer to the MIB, the SIB1, or other SI. Minimum SI may include the MIB and the SIB1. Other SI may refer to SIB3, SIB4, SIB5, or other SIB(s).

Dedicated signaling may refer to, but is not limited to, one or more RRC messages. Examples of the RRC signaling or RRC message(s) may include the RRC (Connection) Setup Request message, the RRC (Connection) Setup message, the RRC (Connection) Setup Complete message, the RRC (Connection) Reconfiguration message, the RRC Connection Reconfiguration message including the mobility control information, the RRC Connection Reconfiguration message without the mobility control information inside, the RRC Reconfiguration message including the configuration with sync, the RRC Reconfiguration message without the configuration with sync inside, the RRC (Connection) Reconfiguration Complete message, the RRC (Connection) Resume Request message, the RRC (Connection) Resume message, the RRC (Connection) Resume Complete message, the RRC (Connection) Reestablishment Request message, the RRC (Connection) Reestablishment message, the RRC (Connection) Reestablishment Complete message, the RRC (Connection) Reject message, the RRC (Connection) Release message, the RRC System Information Request message, the UE Assistance Information message, the UE Capability Enquiry message, and UE Capability Information message.

The mechanisms, methods, approaches described in the present disclosure may be applicable to the RRC_CONNECTED UE (e.g., the UE in the RRC_CONNECTED state), the RRC_INACTIVE UE (e.g., the UE in the RRC_INACTIVE state), and the RRC_IDLE UE (e.g., the UE in the RRC_IDLE state).

The UE may be served by a cell, e.g., a serving cell. The serving cell may serve an RRC_CONNECTED UE, among other types of UEs. The serving cell may be (but is not limited to) a suitable cell.

PCell: an MCG cell, operating on the primary frequency, in which the UE either performs the initial connection establishment procedure or initiates the connection re-establishment procedure.

PSCell: an SCG cell used for dual connectivity operation, in which the UE may perform an RA procedure when performing the Reconfiguration with the synchronization (Sync) procedure.

Serving Cell: for a UE in the RRC_CONNECTED state not configured with CA/DC, there is only one serving cell consisting of the primary cell. For a UE in the RRC_CONNECTED state configured with CA/DC, the term “serving cells” is used to denote the set of cells consisting of the Special Cell(s) and all secondary cells.

Secondary Cell: for a UE configured with CA, the secondary cell may refer to the cell providing additional radio resources on top of the Special Cell.

SpCell: for the DC operation, the Special Cell may refer to the PCell of the MCG or the PSCell of the SCG, otherwise the Special Cell may refer to the PCell.

MCG: in MR-DC, the MCG may refer to a group of serving cells associated with the MN, consisting of the SpCell (e.g., the PCell) and optionally one or more SCells.

MN: in MR-DC, the MN may refer to the radio access node that provides the control plane connection to the core network. The MN may be a Master eNB (in EN-DC), a Master ng-eNB (in NGEN-DC), or a Master gNB (in NR-DC and NE-DC).

SCG: in MR-DC, the SCG may refer to a group of serving cells associated with the SN, consisting of the SpCell (e.g., the PSCell) and optionally one or more SCells.

SN: in MR-DC, the SN may refer to the radio access node, with no control plane connection to the core network, providing additional resources to the UE. The SN may be an en-gNB (in EN-DC), a Secondary ng-eNB (in NE-DC) or a Secondary gNB (in NR-DC and NGEN-DC). en-gNB is a node providing NR user plane and control plane protocol terminations towards the UE, and acting as an SN in EN-DC.

The serving cell described in the present disclosure may refer to a PCell, an SCell or a PSCell.

The source node described in the present disclosure may refer to a source MN, a source PCell, a source PSCell, or a source gNB.

The target cell described in the present disclosure may refer to a PCell, an SCell or a PSCell.

The inter-cell relative to the serving cell of the UE may refer to a neighboring cell, a cell other than the serving cell or a cell with a PCI different from the PCI of the serving cell. If the UE is capable of performing inter-cell beam managements, the UE may be in coverage of the inter-cell.

An RRC_CONNECTED UE may be configured with an active BWP with a common search space configured to monitor the system information or the paging.

The UE may be served by a cell (e.g., serving cell). The serving cell may serve an RRC_CONNECTED UE. The serving cell may be, but is not limited to, a suitable cell.

A suitable cell may refer to a cell on which a UE may camp. The UE may consider a cell as a suitable cell if the following conditions are fulfilled: (1) the cell is part of either the selected PLMN or the registered PLMN or the PLMN of the equivalent PLMN list, and (2) the cell criteria of the cell are fulfilled. Furthermore, according to the latest information provided by the NAS, the suitable cell may not be barred. The suitable cell may be part of at least one TA that is not part of the list of “Forbidden Tracking Areas,” which belongs to the PLMN that fulfils the condition (1).

The target cell may be a suitable cell.

A CPAC may be refer to a CPA, a CPC, or both of them.

A single SA counter may be associated to a PSCell, an SCG configuration, multiple PSCells, and/or multiple SCG configurations.

The inter-node signaling (e.g., between the MN and the SN) in the implementations may be the RRC signaling or the XnAP signaling.

In the present disclosure, although the term “gNB” is used throughout the document, it should be understood that the term “gNB” can be replaced by any other type of BS.

In wireless cellular networks, the MR-DC enables one or more mobile devices (e.g., one or more UEs) to connect to at least two network nodes, such as an MN and at least one SN. The MN and/or the SN may include one or more cells, and the network may configure a mobile device with a group of cells called MCG in the MN and another group of cells called SCG in the SN. It is possible that the network may include one MN and at least one SN, which means that the mobile device may be configured with one MCG and at least one SCG, where each SCG is in the SN. The mobile device may maintain the control and the user plane connections to the PCell among the MCG in the MN and to the PSCell among the SCG in the SN.

The mobile devices may move from a cell to another due to their mobility. When a mobile device moves from a serving cell to a neighbor cell, a mobility event may occur, for example, the quality of the signal received from the source cell falls below a threshold for a period. Then, a handover procedure may be needed to ensure that the mobile device is able to continue the ongoing service in the neighbor cell. The neighbor cell may be a cell close to the source cell. For a mobile device, it is possible that the mobility event for the PSCell occurs while the mobility event for the PCell does not occur. In such cases, the mobile device may change the PSCell while maintaining the connection to the serving PCell, and the procedure is called a PSCell change or a PSCell change procedure. The PSCell change procedure may be further enhanced to become a CPC or a CPC procedure. In the CPC procedure, a mobile device may be configured with (e.g., through multiple CPC configurations) multiple candidate target PSCell configurations and the execution conditions corresponding to the candidate target PSCell configurations. Once an execution condition is satisfied, the mobile device may apply the corresponding PSCell configuration to construct the connection to the PSCell. After executing one of the CPC configurations, the mobile device may release all of the stored CPC configurations.

In addition to the CPC procedure, there is also a conditional procedure for the MR-DC operation, referring to as the CPA or the CPA procedure. For a mobile device operating in the standalone mode (e.g., the mobile device is only connecting to the MN), the network may configure the UE with multiple candidate PSCells, which may belong to different SNs, and the execution conditions corresponding to the candidate PSCells, through multiple CPA configurations. Once an execution condition is satisfied, the mobile device may apply the corresponding PSCell configuration to establish the connection to the PSCell and start operating in the MR-DC. Similar to the CPC procedure, the mobile device may release all of the stored CPA configurations after executing the CPA procedure successfully.

A UE may perform multiple CPC executions when served by the same PCell. An executed CPC configuration may retain the same SCG configuration that was configured and released in the previous CPC execution. For example, a UE may be configured with two CPC configurations for PSCell 1 and PSCell 2. After executing the CPC for PSCell 1, the UE may release both CPC configurations. As the channel quality varies, the UE may then be configured with additional CPC configurations for PSCell 2 and PSCell 3. In this example, the SCG configuration for PSCell 2 may remain the same across the first and second CPC evaluations/executions, despite being released and reconfigured. This release and reconfiguration process may, however, lead to an increased signaling overhead. To reduce the signaling overhead during reconfiguration, the UE may retain the stored CPA or CPC configurations after each CPA or CPC execution.

The CPAC with an SCG Selective Activation

The CPAC procedure with the SCG selective activation may include, but is not limited to, an initial CPAC preparation step with the SCG selective activation and multiple subsequent CPAC evaluation and execution steps. During the CPAC evaluation and execution step, the UE may perform evaluation to determine whether to execute the CPAC. In the present disclosure, the initial preparation step may refer to the initial CPAC with the SCG selective activation preparation step, and the initial preparation may refer to the initial CPAC with the SCG selective activation preparation. For example, the preparation may include determining the radio resource configuration for the candidate PSCell/SCG and performing the signaling exchange to facilitate the determination of the radio resource configuration. The CPAC with the SCG selective activation may be used to reduce the reconfigurations of the CPAC candidate(s) by allowing the UE to retain the stored CPAC candidate configuration(s) after executing the CPAC. The terms “CPAC procedure with the SCG selective activation” and “CPCSA” may be utilized interchangeably in the present disclosure.

In the present disclosure, the following scenario may be considered: a network includes multiple cells, and a UE supports the MR-DC configuration. This means that the UE is able to receive service data from at least two RAN nodes, for example, an MN including a MCG and at least one SN including an SCG. In the present disclosure, the terms “MN” and “master gNB” may be utilized interchangeably; the terms “SN” and “secondary gNB” may be utilized interchangeably. The UE may be configured with multiple receivers and transmitters and capable of supporting the MR-DC-dedicated configurations. The network, aware of the UE's capabilities, may configure the UE with an MR-DC configuration (e.g., the SCG configuration) that is encapsulated in an RRC reconfiguration message and transmitted from the serving gNB/cell to the UE. In the considered scenario, the UE may operate with the MR-DC configuration if the MR-DC is configured by the network, or may not operate with the MR-DC configuration if the MR-DC is not configured by the network.

If the UE is configured with the MR-DC and is operating with the MR-DC configuration, the network may utilize the radio resources provided by two distinct schedulers located in different RAN nodes. The UE may maintain the control and user plane connections to the PCell in the MCG and to the PSCell in the SCG. From the UE's perspective, there may be three types of bearers for the user plane: the MCG bearer, the SCG bearer, and the split bearer. From the network's perspective, each bearer may terminate either in the MN or the SN.

Initial CPAC with the SCG Selective Activation Preparation

In the present disclosure, a source node may refer to at least one of the following: a source MN, a source SN, a source gNB, a source eNB, a source PCell, and a source PSCell. In some implementations, the source node may decide whether to initiate the CPAC with the SCG selective activation and may start the initial CPAC with the SCG selective activation preparation. In some implementations, after the CPAC with the SCG selective activation is initiated, the source node may start the preparation with the involved candidate target nodes. In some implementations, after the CPAC with SCG selective activation is initiated, the source node may start the preparation with the involved candidate target nodes.

In some implementations, the UE may transmit the measurement reports to the source node before performing/executing the initial CPAC with the SCG selective activation preparation. In some implementations, if the SRB3 is configured between the UE and the source SN, the UE may transmit the measurement reports to the source SN via the SRB3.

In some implementations, the source SN may decide to initiate the CPC with the SCG selective activation and start the initial preparation.

In some implementations, the source SN may decide to initiate the CPC with the SCG selective activation. In some implementations, the source SN may send an inter-node signaling message to the MN to indicate the initiation of the CPAC with the SCG selective activation. In some implementations, after receiving the indication message from the source SN, the source MN may start the initial preparation.

In some implementations, the MN may decide to initiate the CPC with the SCG selective activation and start the initial preparation.

In some implementations, the MN may decide to initiate the CPA with the SCG selective activation and start the initial preparation.

After the CPAC with the SCG selective activation is initiated, the source node may start the initial preparation involving the candidate target node(s), the source MN, and/or the source SN.

In some implementations, the source SN may determine at least one of the following: (1) the candidate target PSCells for the CPC with the SCG selective activation, (2) the corresponding radio configurations (e.g., the radio configurations for the UE to establish the radio connections with the target PSCells), (3) the corresponding execution conditions, and (4) one or more selective activation (SA) counters for the prepared PSCells.

In some implementations, the SA counter may be associated with a single SCG configuration. For example, the SA counter may be specific for an associated SCG configuration, and/or be specific for the SCG indicated by the associated SCG configuration.

In some implementations, the SA counter may be associated with multiple SCG configurations. For example, the SA counter may be common for all associated SCG configurations and/or common for the SCGs indicated by all associated SCG configuration.

In some implementations, the SA counter may be associated with a single PSCell. For example, the SA counter may be specific for an associated PSCell.

In some implementations, the SA counter may be associated with multiple PSCells. For example, the SA counter may be common for all associated PSCells.

In some implementations, the source SN may indicate the initiation of the CPC with the SCG selective activation to the MN through the inter-node signaling (1st message). The MN may send a request for the CPC with the SCG selective activation preparation to the candidate target SNs, so as to indicate the preparation of the CPC with the SCG selective activation through the inter-node signaling (2nd message). Upon receiving the request for the CPC with the SCG selective activation preparation, the candidate target SN may prepare the candidate target PSCells (e.g., determining the radio resource configuration associated with the candidate target PSCells) and the radio configurations (e.g., the radio configurations for the UE to establish radio connections with the target PSCells) corresponding to the candidate target PSCells. Then, the candidate target SN may respond to the MN for the CPC with the SCG selective activation preparation through the inter-node signaling (3rd message). Upon receiving the responses from all of the candidate target SNs, the MN may indicate the prepared PSCells to the source SN through the inter-node signaling (4th message). Upon receiving the indication from the MN, the source SN may generate the execution condition for each of the prepared candidate target PSCells and then reply the information of the execution conditions to the MN through the inter-node signaling (5th message).

The inter-node signaling from the source SN to the MN (the 1st message) may include at least one of the following: the cell IDs of the recommended PSCells (e.g., especially the candidate target PSCells associated by the source SN), the measurement results reported by the UE, and the indication of the (SCG) selective activation.

The inter-node signaling from the MN to the candidate target SN (the 2nd message) may include at least one of the following: the cell IDs of the recommended PSCells, the measurement results of the cells associated with the candidate target SN, the current MCG and SCG configuration of the UE, the expected MCG and SCG configuration of the UE, the maximum number of the PSCells that the candidate target SN can prepare, the indication of the (SCG) selective activation, an indication of the request for the maximum value of the SA counter(s). The maximum value(s) of the SA counter(s) may refer to the initial value(s) of the SA counter(s).

The inter-node signaling from the candidate target SN to the MN (the 3rd message) may include the prepared PSCell IDs, the corresponding SCG configuration, and/or the maximum value of the SA counter(s) for the prepared PSCells.

In some implementations, if the target SN does not receive an indication of the request for the maximum value of the SA counter in the 2nd message, the target SN may not include the SA counters in the 3rd message.

In some implementations, if the target SN receives an indication of the request for the maximum value of the SA counter in the 2nd message, the target SN may include the SA counters. It is noted that the SA counter(s) may be specific for an associated SCG configuration or may be common for all associated SCG configurations.

The SCG configuration may be a complete configuration or a delta configuration. In some implementations, the inter-node signaling from the candidate target SN to the MN (the 3rd message) may include an indication field that indicates whether the SCG configuration is a complete configuration or a delta configuration. For example, the indication field may have an ENUMERATED format. The indication field may be one of the values in {‘TRUE’} or one of the values in {‘COMPLETE’, ‘DELTA’}.

If the SCG configuration is a complete configuration, the UE may directly apply the complete configuration for the SCG (e.g., the UE may directly apply the complete configuration to establish a connection to the SCG). If the SCG configuration is a delta configuration, the UE may need to combine the SCG configuration with a preconfigured reference configuration to obtain a complete configuration. The UE may then apply the complete configuration for the SCG. The SCG configuration may include the radio bearer configuration, the SDAP configuration, the PDCP configuration, the RLC configuration, the MAC configuration and the PHY configuration that the UE requires to establish a connection to the SCG in the corresponding candidate target SN.

The inter-node signaling from the MN to the source SN (the 4th message) may include the cell IDs of all the prepared PSCells for the CPC with the SCG selective activation. All of the prepared PSCells may correspond to all of the prepared PSCells indicated by the candida target SN(s).

The inter-node signaling from the source SN to the MN (the 5th message) may include a measurement configuration and an execution condition. The measurement configuration and the execution condition may be associated with all prepared PSCells or a prepared PSCell. Additionally or alternatively, the inter-node signaling from the source SN to the MN (the 5th message) may include multiple pairs of a measurement configuration and an execution condition. Each pair of the measurement configuration and the execution condition may be associated with a prepared PSCell.

In some implementations, the MN may select the candidate target PSCells and send a request for a CPC with an SCG selective activation preparation to the candidate target SNs, so as to indicate the preparation of the CPC with the SCG selective activation through the inter-node signaling. Upon receiving the request, the candidate target SN may prepare the candidate target PSCells and the radio configurations corresponding to the candidate target PSCells, then the candidate target SN may respond to the MN for the CPC with the SCG selective activation preparation through the inter-node signaling. Upon receiving the responses (e.g., the acknowledgement/rejection of the recommended candidate target PSCells, and/or the corresponding prepared/determined radio resource configuration(s) for the candidate target PSCells) from all of the candidate target SNs, the MN may determine the execution condition for each of the prepared candidate target PSCells.

The inter-node signaling from the MN to the candidate target SN may include at least one of the following: the cell ID(s) of the PSCell(s) (e.g., selected/suggested/recommended by the MN), the measurement results of the cells associated with the candidate target SN, the current MCG and SCG configuration of the UE, the reference/expected MCG and SCG configuration of the UE, the maximum number of the PSCells that the candidate target SN can prepare, an indication of whether the candidate target SN responds with the SCG configuration in a reference form or in a delta form, an indication of the selective activation, and an indication of the request for the maximum value of the SA counter(s).

If the MN does not provide the cell ID of the selected PSCells in the inter-node signaling, the candidate target SN may prepare the PSCells according to the measurement results. The inter-node signaling from the candidate target SN to the MN may include the PSCell IDs (e.g., prepared by the candidate target SN) and/or the corresponding SCG configuration, and/or the maximum value of the SA counter(s) for the prepared PSCells. The SCG configuration may be a complete configuration (e.g., the UE may directly apply for the SCG) or a delta configuration (e.g., the UE may need to combine the SCG configuration with a preconfigured reference configuration to obtain a complete configuration, and then the UE may apply the complete configuration for the SCG). For example, if the MN indicates the candidate target SN to reply a complete SCG configuration, or if the MN does not indicate the form of the SCG configuration, or if the MN does not provide the reference SCG configuration, the SCG configuration may be a complete configuration. If the MN indicates the candidate target SN to reply delta SCG configuration, or if the MN does not indicate the form of the SCG configuration, or if the MN provides the reference SCG configuration, the SCG configuration may be a delta configuration. The SCG configuration may include the radio bearer configuration, the SDAP configuration, the PDCP configuration, the RLC configuration, the MAC configuration and the PHY configuration that the UE requires to establish the SCG in the corresponding candidate target SN.

In some implementations, if the target SN does not receive an indication of the request for the maximum value of SA counters in the inter-node signaling from the MN, the target SN may not include the maximum value of the SA counters in the inter-node signaling to the MN.

In some implementations, if the target SN does not receive an indication of the request for the maximum value of SA counters in the inter-node signaling from the MN, the target SN may include the maximum value of the SA counters in the inter-node signaling to the MN. In this case, upon receiving the maximum value of the SA counters, the MN may realize that the counter-based approach should be applied. The reception of the maximum value(s) of the SA counter(s) may lead the MN to apply the counter-based approach.

In some implementations, if the target SN receives an indication of the request for the maximum value of SA counters in the inter-node signaling from the MN, the target SN may include the maximum value of the SA counters in the inter-node signaling to the MN.

In some implementations, the MN may select the candidate target PSCells and send a request for a CPA with the SCG selective activation preparation to the candidate target SNs, so as to to indicate the preparation of the CPA with the SCG selective activation through the inter-node signaling. Upon receiving the request of the CPA with the SCG selective activation preparation, the candidate target SN may prepare the candidate target PSCells along with the radio configurations corresponding to the candidate target PSCells and/or the cell group configurations corresponding to the candidate target PSCells, then the candidate target SN may respond to the MN for the CPA with the SCG selective activation preparation through the inter-node signaling. Upon receiving the responses from all the candidate target SNs, the MN may determine the execution conditions of each prepared candidate target PSCell.

The inter-node signaling from the MN to the candidate target SN may include at least one of the following: the cell ID of the selected PSCells, the measurement results of the cells associated with the candidate target SN, the current MCG and SCG configuration of the UE, the expected MCG and SCG configuration of the UE, and the maximum number of the PSCells that the candidate target SN can prepare, an indication of the selective activation, and an indication of the request for the maximum value of the SA counter(s).

The inter-node signaling from the candidate target SN to the MN may include the prepared PSCell IDs, the corresponding SCG configuration, and/or the maximum value of the SA counter(s) for the prepared PSCells.

The inter-node signaling from the candidate target SN to the MN may contain an indication field that indicates whether the SCG configuration is a complete configuration or a delta configuration. For example, the indication field may have an ENUMERATED format. The indication field may be set to one of the values in {‘TRUE’} or one of the values in {‘COMPLETE’, ‘DELTA’}. The SCG configuration may be a complete configuration (e.g., the UE may directly apply for the SCG) or a delta configuration (e.g., the UE may need to combine the SCG configuration with a preconfigured reference configuration to obtain a complete configuration, and then the UE may apply the complete configuration for the SCG). The SCG configuration may include the radio bearer configuration, the SDAP configuration, the PDCP configuration, the RLC configuration, the MAC configuration and the PHY configuration that the UE requires to establish the SCG in the corresponding candidate target SN.

If the target SN does not receive an indication of the request for the maximum value of the SA counter(s) in the inter-node signaling from the MN, the target SN may not include the maximum value of the SA counters in the inter-node signaling to the MN. Additionally or alternately, if the target SN does not receive an indication of the request for the maximum value of the SA counters in the inter-node signaling from the MN, the target SN may include the maximum value of the SA counters in the inter-node signaling to the MN. In this case, upon receiving the maximum value of the SA counters, the MN may realize that the counter-based approach should be applied. The reception of the maximum value(s) of the SA counter may lead the MN to apply the counter-based approach. Additionally or alternately, if the target SN receives an indication of the request for the maximum value of the SA counter(s) in the inter-node signaling from the MN, the target SN may include the maximum value of the SA counter(s) in the inter-node signaling to the MN.

The execution conditions for each prepared candidate target PSCell may include one or two sets of measurement events, where each set of measurement events may include one or two measurement events. In some implementations, the first set of measurement events may be used for the evaluation of the initial CPA condition, and the second set of the measurement events may be stored by the UE and used for the subsequent CPC condition(s).

Configuration of the Initial CPAC with the SCG Selective Activation

In some implementations, after the initial preparation is completed, the source node may transmit the configuration of the CPAC with the SCG selective activation to the UE via the RRC signaling. In the present disclosure, a CPASA Candidate Configuration may refer to a configuration of a CPA with an SCG selective activation associated with a PSCell; a CPCSA Candidate Configuration may refer to a configuration of a CPC with an SCG selective activation associated with a PSCell. In some implementations, a UE may maintain/retain an indication associated with a CPASA/CPCSA Candidate Configuration to indicate whether the configuration is activated or suspended. For example, the indication may include one of the values in the set {‘Activated’, ‘Suspended’} to indicate the configuration is activated or suspended.

In some implementations, if the MN does not request the candidate target SNs for the SA counters, the MN may generate one or multiple SA counters for the CPCSA/CPASA Candidate Configurations.

In some implementations, the source SN may transmit one or more RRC messages to configure the CPCSA Candidate Configurations to the UE.

In some implementations, the MN may transmit one or more RRC messages to configure the CPCSA Candidate Configurations to the UE.

In some implementations, the MN may transmit one or more RRC messages to configure the CPASA Candidate Configurations to the UE.

In some implementations, the RRC message (e.g., transmitted by the source SN and/or the MN for configuring the CPCSA Candidate Configurations to the UE) may include a list of sequences including a measurement event and an ID for the measurement event.

In some implementations, the source node may transmit to the UE a separate RRC message including a list of sequences including a measurement event and an ID for the measurement event.

In some implementations, the RRC message (e.g., transmitted by the source SN and/or the MN for configuring the CPCSA/CPASA Candidate Configurations to the UE) may include one or multiple CPCSA/CPASA Candidate Configurations.

In some implementations, the RRC message (e.g., transmitted by the source SN and/or the MN for configuring the CPCSA Candidate Configurations to the UE) may include one or multiple CPASA Candidate Configurations.

In some implementations, the SA counter may be associated with a single CPCSA/CPASA Candidate Configurations.

In some implementations, the SA counter may be associated with all CPCSA/CPASA Candidate Configurations.

In some implementations, the SA counter may be configured in the CPCSA/CPASA Candidate Configurations.

In some implementations, if multiple SA counters are configured for different CPCSA/CPASA Candidate Configurations, the maximum values of the SA counters may be the same or may be different.

In some implementations, the SA counter may be configured separately from the CPCSA/CPCSA Candidate Configurations. The network may provide an additional information of the association between the SA counter and the CPCSA/CPCSA Candidate Configurations.

In some implementations, one or more RRC messages, referred to as pre-transmitted RRC messages, may be transmitted before the CPCSA Candidate Configurations and the CPASA Candidate Configurations. Each pre-transmitted RRC message may include a reference MCG configuration and a reference SCG configuration. A UE may obtain a complete MCG configuration and/or a complete SCG configuration by combining the reference configuration with the delta configuration that is configured in the CPCSA Candidate Configuration and/or the CPASA Candidate Configuration. For example, a single pre-transmitted RRC message including the reference MCG and/or SCG configuration may be generally applied to all of the CPASA and/or CPCSA Candidate Configurations. Additionally or alternatively, the single pre-transmitted RRC message (including the reference MCG and/or SCG configuration) may be specifically applied to those CPASA and/or CPCSA Candidate Configurations associated with a specific group of PSCells.

In some implementations, a CPCSA/CPASA Candidate Configuration may include at least one of the following: an indication of the CPCSA/CPASA, a candidate target PSCell ID, one or two execution conditions, one or two conditional configurations, and the maximum value of the SA counter(s).

The indication of the CPCSA/CPASA, which may be an IE, may indicate that the configuration may be retained after the UE performs the CPC/CPA. An IE of the PSCell ID (or “PSCell ID IE”) may indicate (or include) the identity or the index of the candidate target PSCell.

An IE of the execution condition (or “execution condition IE”) may indicate/include an IE of the measurement event (or “measurement event IE”). A UE may apply/use the conditional configuration once the UE determines that the measurement event is satisfied.

For example, if the measurement event list is preconfigured, the execution condition IE may include an ID indicating which measurement event to be applied. The measurement event IE may include an offset, a hysteresis, and/or a TTT duration. A UE may consider the entering/triggering condition for the event to be satisfied when the measurement result value (e.g., an RSRP value) of the candidate target PSCell minus the hysteresis becomes better than the measurement result value of the source PSCell for the offset. The UE may consider the measurement event is satisfied when the entering condition for the event is considered to be satisfied for the duration TTT.

The measurement event IE may include a threshold, a hysteresis, and/or a TTT duration. A UE may consider the entering condition for an event to be satisfied when the measurement result value of the candidate target PSCell minus the hysteresis becomes better than the threshold. The UE may consider the measurement event is satisfied when the entering condition for the event is considered to be satisfied for the duration TTT. Additionally or alternatively, the measurement event IE may include two thresholds (e.g., a first threshold and a second threshold), a hysteresis, and/or a TTT duration. A UE may consider the entering condition for the event to be satisfied when the measurement result value of the source PSCell plus the hysteresis becomes worse than the first threshold and the measurement result value of the candidate target PSCell minus the hysteresis becomes better than the second threshold. The UE may consider the measurement event is satisfied when the entering condition for the event is considered to be satisfied for the duration TTT. The value of the first threshold and the value of the second threshold may be the same or different.

An IE of the conditional configuration (or “conditional configuration IE”) may indicate the RRC configuration to be applied by the UE when the execution condition is considered to be satisfied. The RRC configuration may be an MCG configuration and/or an SCG configuration. The conditional configuration IE may be a single IE including an MCG configuration, an SCG configuration, and/or other RRC reconfigurations such as the radio bearer configuration.

If multiple conditional configuration IEs are present, these conditional configuration IEs may be separate IEs. One of these IEs may include an MCG configuration, while each of the remaining IEs may include an SCG configuration. It should be noted that the MCG configuration may be a complete configuration that a UE may directly apply for the MCG (e.g., the UE may directly apply the complete configuration to establish a connection to the MCG), or a delta configuration that a UE may combine with a preconfigured reference configuration to obtain the complete configuration and then apply the obtained complete configuration for the MCG. Moreover, the SCG configuration may be a complete configuration that a UE can directly apply for the candidate target SCG, or a delta configuration that a UE may combine with a preconfigured reference configuration to obtain the complete configuration and then apply the obtained complete configuration for the candidate target SCG.

In some implementations, the CPASA Candidate Configuration may include at least one of the following: an indication of the CPASA, a candidate target PSCell ID, one or two sets of execution conditions (e.g., each set may include one or two execution conditions), and one or two conditional configurations. The IE of the indication of the CPASA may indicate that the configuration may be retained after the UE performs the CPA. The PSCell ID IE may indicate the identity or the index of the candidate target PSCell. The execution condition IE may indicate the measurement event IEs.

A UE may apply/use the conditional configuration when the UE considers that the measurement event is satisfied; alternatively, the UE may store the measurement event for the subsequent CPC.

If the measurement event list is preconfigured, the execution condition IE may include an ID indicating which measurement event to be applied. The measurement event IE may include a threshold, a hysteresis, and a TTT duration. A UE may consider the entering condition for an event to be satisfied when the measurement result value of the candidate target PSCell minus the hysteresis becomes better than the threshold. The UE may consider the measurement event is satisfied when the entering condition for the event is considered to be satisfied for the duration TTT. If the execution condition IE includes only one set of measurement events, a UE may apply the conditional configuration when the UE considers that the entire set of measurement events is satisfied. If there are two sets of measurement events, a UE may apply the first set of measurement events and store the second set of measurement events for the subsequent CPC. That is, the UE may apply the conditional configuration only when the UE considers that the first set of measurement events is satisfied. In the present disclosure, a set of measurement events (e.g., a first set of measurement events or a second set of measurement events) may include one or multiple measurement events.

The maximum value of the SA counter(s) may be an integer format and indicate the maximum times of the allowed subsequent CPC/CPA executions after which the UE may release the corresponding CPCSA/CPASA Candidate Configuration.

The conditional configuration IE may indicate the RRC configuration that the UE applies when the execution condition is considered to be satisfied. The RRC configuration may be an MCG configuration and/or an SCG configuration. The conditional configuration IE may be a single IE including an MCG configuration IE, and/or an SCG configuration, and/or other RRC reconfigurations such as radio bearer configuration.

If multiple conditional configuration IEs are present, these conditional configuration IEs may be separate IEs. One of these IEs may include an MCG configuration, while each of the remaining IEs may include an SCG configuration. It should be noted that the MCG configuration may be a complete configuration that a UE can directly apply for the MCG or a delta configuration that a UE may combine with a preconfigured reference configuration to obtain the complete configuration and then apply the obtained complete configuration for the MCG. The SCG configuration may be a complete configuration that a UE can directly apply for the candidate target SCG or a delta configuration that a UE may combine with a preconfigured reference configuration to obtain the complete configuration and then apply the obtained complete configuration for the candidate target SCG.

In some implementations, a UE may maintain/retain an indication list in the RRC layer of the UE, where the indication list may indicate the activation/suspension of all of the stored CPCSA/CPASA Candidate Configurations. Each entry of the indication list may indicate the status (e.g., activated, suspended) of the corresponding stored CPCSA/CPASA Candidate Configuration.

The UE may update the indication list in a case that the UE receives the RRC signaling or the MAC CE from the source node. The RRC signaling or the MAC CE may include the information of the indication list to be updated and/or the information of the new indication list used for updating the stored indication list. The UE may remove an entry in the indication list in a case that the corresponding CPCSA/CPASA Candidate Configuration has been released. The UE may release the indication list in a case that all of the CPCSA/CPASA Candidate Configurations have been released (e.g., an empty list with no entry). The UE may maintain/retain an indication field in a stored CPCSA/CPASA Candidate Configuration to indicate the activation/suspension of the corresponding CPCSA/CPASA Candidate Configuration. The indication field, e.g., in a format of ENUMERATED {activated, suspended}, may indicate the status of the corresponding stored CPCSA/CPASA Candidate Configuration.

The UE may receive the RRC signaling as a reference MCG and/or SCG configuration before receiving the CPCSA Candidate Configuration(s) or the CPASA Candidate Configuration(s). The UE may store the preconfigured reference MCG and/or SCG configuration. After receiving the configuration of the CPC/CPA with the SCG selective activation through the RRC signaling from the source node, the UE may store and/or apply the information/configuration in the CPCSA. The UE may set the suspension field to ‘Activated’ upon receiving the CPCSA Candidate Configuration(s) or the CPASA Candidate Configuration(s).

In response to receiving the CPCSA/CPASA Candidate Configuration(s), the UE may apply the PSCell ID and the execution conditions in order to start evaluating the execution conditions of the candidate target PSCell. Additionally or alternatively, in response to receiving the CPCSA/CPASA Candidate Configuration(s), the UE may store the conditional configuration IE. Additionally or alternatively, in response to receiving the CPCSA/CPASA Candidate Configuration(s), the UE may apply the conditional configuration IE to the stored reference MCG and/or SCG configuration and obtain a complete MCG and/or SCG configuration. The UE may then store the complete MCG and/or SCG configuration.

In some implementations, after receiving the configuration of the CPA with the SCG selective activation through the RRC signaling, the UE may store and/or apply the information/configuration in the CPASA. In some implementations, the UE may set the suspension field to ‘Activated’ upon receiving the CPASA.

In some implementations, in response to receiving the CPASA Candidate Configuration, the UE may apply the PSCell ID and the first set of measurement events for the execution condition in order to start evaluating the execution conditions of the candidate target PSCell. Additionally or alternatively, in response to receiving the CPASA Candidate Configuration, the UE may store the second set of measurement events, if configured. Additionally or alternatively, in response to receiving the CPASA Candidate Configuration, the UE may store the conditional configuration IE. The UE may set the suspension field to ‘Activated’. Additionally or alternatively, in response to receiving the CPASA Candidate Configuration, the UE may apply the conditional configuration IE to the stored reference MCG and/or SCG configuration and obtain a complete MCG and/or SCG configuration. The UE may store the complete MCG and/or SCG configuration. The UE may set the suspension field to ‘Activated’.

With the reception of CPCSA/CPASA Candidate Configuration and the SA counter information (if configured separately), the UE may apply the maximum value of the SA counter(s) to the configured CPCSA/CPASA Candidate Configurations. The SA counter information may include the maximum value of the SA counter.

If the network configures that an SA counter is associated with a single CPCSA/CPASA Candidate Configuration, upon the reception of the SA counter information, the UE may store each maximum value of the SA counter in the corresponding variable storing the CPCSA/CPASA Candidate Configuration.

If the network configures that an SA counter is associated with a single CPCSA/CPASA Candidate Configuration, upon the reception of the SA counter information, the UE may store the maximum values of the SA counters as a list separately from the variable storing the CPCSA/CPASA Candidate Configuration. The UE may store the maximum SA counter list in the variable along with all variables containing the CPCSA/CPASA Candidate Configurations.

If the network configures that an SA counter is associated with all the CPCSA/CPASA Candidate Configurations, upon the reception of the SA counter information, the UE may store the maximum value of the SA counter separately from the variable storing the CPCSA/CPASA Candidate Configurations. The UE may store the maximum value of the SA counter in the variable along with all variables containing the CPCSA/CPASA Candidate Configurations.

The MAC layer of the UE and/or the RRC layer of the UE may maintain the SA counter(s). If the network configures one or multiple maximum values of SA counters, the UE may start the associated SA counters and initialize them to the corresponding configured maximum values.

CPAC with the SCG Selective Activation Execution and the Subsequent Configuration

In some implementations, a UE configured with the CPAC with the SCG selective activation may keep evaluating the execution conditions of the candidate target PSCells. Once the UE considers the execution condition(s) and/or measurement event(s) of a candidate target PSCell to be satisfied, the UE may apply the corresponding conditional configuration as the beginning of the execution, and the UE may send an RRC message (e.g., an RRC Reconfiguration Complete message) to the MN or the source SN to indicate the application of the conditional configuration, and the UE may start to establish the connection to the target PSCell. The RRC message sent by the UE may include the CPCSA/CPASA Candidate Configuration ID.

Upon executing the CPA/CPC, the UE may apply the corresponding conditional configuration and perform the random access procedure to establish the connection to the target PSCell. The UE may retain the stored CPASA/CPCSA Candidate Configurations even after the CPA/CPC is completed.

If the conditional configuration of the satisfied CPASA Candidate Configuration is a delta configuration, and the UE has not obtained the complete conditional configuration, the UE may combine the delta conditional configuration with the preconfigured reference conditional configuration and obtain a complete conditional configuration. Then, the UE may apply the obtained complete conditional configuration to establish the connection to the target PSCell.

The UE may convert the CPASA Candidate Configurations into the CPCSA Candidate Configurations and keep evaluating the execution conditions of the candidate target PSCells.

Upon sending the RRC message/signaling to the source node, the UE may set the suspension fields of all CPASA Candidate Configurations to ‘Suspended’ and suspend the evaluation on all candidate target PSCells until the network provides a new indication on whether to release, activate, or suspend each of the CPCSA Candidate Configurations. The indication may be provided through the RRC or MAC CE signaling.

Additionally or alternatively, after sending the RRC message/signaling to the source node, the UE may start a timer, set the suspension field of all CPASA Candidate Configurations to ‘Suspended’, and suspend the evaluation on all candidate target PSCells. The maximum value of the timer may be preconfigured to the UE via one of the RRC messages containing the CPASA Candidate Configurations. Additionally or alternatively, the maximum value of the timer may be preconfigured to the UE via an RRC message that is separate from the CPASA Candidate Configurations. Once the timer expires, the UE may set the suspension field of all CPASA Candidate Configurations to ‘Activated’, and start the evaluation on all candidate target PSCells. If the UE receives a message from the network that instructs the UE to keep/suspend/release one or more CPASA Candidate Configurations before the timer expires, the UE may follow the network's instruction and cancel/stop the timer. In the present disclosure, “keeping” a configuration may refer to maintaining or retaining this configuration. Consequently, the UE keeping a CPASA Candidate Configuration may refer to the UE maintaining or retaining the CPASA Candidate Configuration.

For each CPASA Candidate Configuration, the UE may release the first set of measurement events and apply the second set of measurement events for the execution condition to the CPASA and obtains the CPCSA Candidate Configuration. The UE may keep evaluating the new execution conditions of the candidate target PSCells of the CPCSA Candidate Configurations.

The RRC message sent by the UE to the MN may include the CPASA ID whose corresponding execution condition(s) is considered to be satisfied. The CPASA ID may identify a CPASA Candidate Configuration.

In some implementations, upon executing the CPC, the UE may apply the corresponding conditional configuration and perform the random access procedure to establish the connection to the target PSCell. The UE may keep the stored CPCSA Candidate Configurations.

If the conditional configuration of the satisfied CPCSA Candidate Configuration is a delta configuration, and the UE has not obtained the complete conditional configuration, the UE may first combine the delta conditional configuration with the preconfigured reference conditional configuration and obtain a complete conditional configuration. Then, the UE may apply the obtained complete conditional configuration to establish the connection to the target PSCell.

The UE may keep evaluating the execution conditions of the candidate target PSCells of the CPCSA Candidate Configurations.

The UE may set the suspension field of all CPCSA Candidate Configurations to ‘Suspended’ and suspend the evaluation on all candidate target PSCells until the network provides a new indication on whether to release, activate, or suspend each of the CPCSA Candidate Configurations. In some implementations, the indication may be provided to the UE through the RRC signaling or through the MAC CE signaling.

After sending the RRC signaling to the source node, the UE may start a timer, set the suspension field of all CPCSA Candidate Configurations to ‘Suspended’, and suspend the evaluation on all candidate target PSCells. The maximum value of the timer may be preconfigured to the UE via one of the RRC messages containing the CPASA Candidate Configurations. Additionally or alternatively, the maximum value of the timer may be preconfigured to the UE via an RRC message that is separate from the CPASA Candidate Configurations (e.g., an RRC message that does not carry the CPASA Candidate Configurations). Once the timer expires, the UE may set the suspension field of all CPCSA Candidate Configurations to ‘Activated’, and start the evaluation on all candidate target PSCells. If the UE receives a message instructing the UE to keep/suspend/release certain CPCSA Candidate Configurations from the network before the timer expires, the UE may follow the network's instruction and cancel/stop the timer.

In some implementations, the RRC message sent by the UE to the MN or the source MN may include the CPCSA ID whose corresponding execution condition(s) is considered to be satisfied. After the UE sends the RRC message to the MN or the source SN to indicate the completion of RRC configuration, there may be a signaling exchange among the MN, the source SN, and the target SN, in order to update the information of the UE and the CPCSA Candidate Configurations.

In some implementations, the source SN and the target SN may be the same network node.

The source SN may generate and update the execution conditions and/or the conditional configurations of CPCSA Candidate Configurations for the next CPC.

The source SN may determine whether to keep, suspend, or release each of the CPCSA Candidate Configurations.

If the received CPCSA Candidate Configurations are from the source SN, the UE may send the RRC message to the source SN to indicate the configuration completion, and the source SN may or may not update the SCG configuration to the MN through the inter-node signaling.

If the received CPCSA Candidate Configurations are from the MN, the UE may send the RRC message to the MN to indicate the configuration completion (e.g., the UE completes the random access procedure towards the target SN), and the MN may update the SCG configuration to the source SN through the inter-node signaling.

The source SN may send the subsequent CPCSA configuration and/or the keep/suspend/release indication (e.g., the indication of keeping/suspending/releasing the subsequent CPCSA configuration after the CPCSA) to the MN through the inter-node signaling. The inter-node signaling for the subsequent CPCSA configuration may include all CPCSA Candidate Configurations for the subsequent CPC. Additionally or alternatively, the inter-node signaling for the subsequent CPCSA configuration may include only the CPCSA Candidate Configurations that are updated for the subsequent CPC. Additionally or alternatively, the inter-node signaling of the keep/suspend/release indication may include a single message containing a list of N ENUMERATED values for N CPCSA Candidate Configurations, where N is a positive integer. In some implementations, the ENUMERATED value may be one of the options in the set {‘keep’, ‘suspend’, ‘release’}, and each ENUMERATED value may correspond to a CPCSA Candidate Configuration, where the option ‘keep’ may indicate that the CPCSA Candidate Configuration is kept (e.g., maintained or retained), the option ‘suspend’ may indicate that the CPCSA Candidate Configuration is suspended, and the option ‘release’ may indicate that the CPCSA Candidate Configuration is released. Additionally or alternatively, the inter-node signaling of the keep/suspend/release indication may include a single message, where the message may include a list of CPCSA IDs to be released and/or a list of CPCSA IDs to be suspended.

The inter-node signaling of keep/suspend/release indication may include a first message of a suspension indication and a second message of a release indication. The first message may include a list of CPCSA IDs to be suspended (e.g., the CPCSA Candidate Configurations corresponding to the CPCSA IDs in the list are indicated to be suspended). Additionally or alternatively, the first message may include N bits for N CPCSA Candidate Configurations, where N is a positive integer. For each bit, the corresponding CPCSA Candidate Configuration may be suspended if the bit is 0 and activated if the bit is 1, or may be suspended if the bit is 1 and activated if the bit is 0. The second message may include a list of CPCSA IDs to be released (e.g., the CPCSA Candidate Configurations corresponding to the CPCSA IDs in the list are indicated to be released). Additionally or alternatively, the second message may include N bits, each bit corresponding to one of the N CPCSA Candidate Configurations, where N is a positive integer. For each bit, the corresponding CPCSA Candidate Configuration may be released if the bit is 0 and maintained if the bit is 1, or may be released if the bit is 1 and maintained if the bit is 0.

The source SN may release the PSCells and the prepared SCG configurations which are associated with the released CPCSA Candidate Configurations.

In some implementations, the source SN and the target SN may be different network nodes. In this case, the UE may send an RRC message to the MN to indicate the CPCSA ID(s) whose corresponding execution condition(s) considered to be satisfied. The MN may identify the target SN to which the target PSCell belongs. The MN and/or the target SN may decide to keep, suspend, or release each CPCSA Candidate Configuration right after receiving the RRC Reconfiguration Complete message from the UE, and may generate the new execution condition(s) for each non-released CPCSA Candidate Configuration. If there is no source SN, the UE may send an RRC message to the MN to indicate the CPASA ID(s) whose corresponding execution condition(s) considered to be satisfied. The MN may identify the target SN to which the target PSCell belongs. The MN and/or the target SN may convert the CPASA Candidate Configurations into the CPCSA Candidate Configurations, and may decide to keep, suspend, or release each CPCSA Candidate Configuration, and may generate the new execution condition(s) for each non-released CPCSA Candidate Configuration.

The MN may decide to keep, suspend, or release each of the CPCSA Candidate Configurations. For each non-released CPCSA Candidate Configuration, the MN may generate the new execution condition(s) for the subsequent CPC. In some implementations, the MN may inform the target SN of the CPCSA Candidate Configuration that the UE applies to the current CPC via the inter-node signaling.

The initial CPAC with the SCG selective activation may be initiated by the source SN, and the MN may send a message to the target SN via the inter-node signaling. The message may include the information of the CPCSA Candidate Configuration whose corresponding execution condition(s) considered to be satisfied, and/or the SCG configuration that the UE applies to the current CPC, and/or all CPCSA Candidate Configurations that were configured to the UE. The target SN may determine to keep, suspend, or release each of the CPCSA Candidate Configurations. For each non-released CPCSA Candidate Configuration, the target SN may generate the new execution condition(s) of the subsequent CPC. The target SN may send to the MN, via the inter-node signaling, the information of its decision on keeping/suspending/releasing and the updated execution condition(s) for each non-released CPCSA Candidate Configuration.

The inter-node signaling of the keep/suspend/release indication may include a single message, which includes a list of N ENUMERATED values for N CPCSA Candidate Configurations, where N is a positive integer. The ENUMERATED value may be one of the options in the set {‘keep’, ‘suspend’, ‘release’} or the set {‘keep’, ‘suspend’, ‘release’, spare}, and each ENUMERATED value may correspond to a CPCSA Candidate Configuration or correspond to a spare meaning for a future use. The option ‘keep’ may indicate that the CPCSA Candidate Configuration is kept, the option ‘suspend’ may indicate that the CPCSA Candidate Configuration is suspended, the option ‘release’ may indicate that the CPCSA Candidate Configuration is released.

Additionally or alternatively, the inter-node signaling of the keep/suspend/release indication may include a single message, where the message may include a list of CPCSA IDs to be released and/or a list of CPCSA IDs to be suspended.

Additionally or alternatively, the inter-node signaling of the keep/suspend/release indication may include a first message of a suspension indication and a second message of a release indication. For example, the first message may include a list of CPCSA IDs to be suspended (e.g., the CPCSA Candidate Configurations corresponding to the CPCSA IDs in the list are indicated to be suspended). Additionally or alternatively, the first message may include N bits, each bit corresponding to one of N CPCSA Candidate Configurations, where N is a positive integer. For each bit, the corresponding CPCSA Candidate Configuration may be suspended if the bit is 0 and activated if the bit is 1, or may be suspended if the bit is 1 and activated if the bit is 0. The second message may include a list of CPCSA IDs to be released. Additionally or alternatively, the second message may include N bits, each bit corresponding to one of N CPCSA Candidate Configurations, where N is a positive integer. For each bit, the corresponding CPCSA Candidate Configuration may be released if the bit is 0 and kept if the bit is 1, or may be released if the bit is 1 and kept if the bit is 0.

After the update of CPCSA Candidate Configurations, for the released CPCSA Candidate Configurations, the MN may send messages to the associated SNs via inter-node signaling to indicate the release. The SNs receiving the message may release the PSCells and prepared SCG radio configurations that are associated with the released CPCSA Candidate Configurations.

In some implementations, for the MN-initiated inter-SN CPCSA, the MN may generate the updated execution conditions for the subsequent CPC every time when the UE executes the CPC.

In some implementations, for the MN-initiated inter-SN CPCSA, the MN may request the target SN to generate the updated execution conditions for the subsequent CPC via the inter-node signaling. In some implementations, after receiving the request from the MN, the target SN may generate the updated execution conditions and respond to the MN. The inter-node signaling from the MN to the target SN may include the CPCSA/CPASA Candidate Configurations configured to the UE. If the measurement event list is preconfigured to the UE, the inter-node signaling from the MN to the target SN may include the measurement event list and the corresponding IDs. The inter-node signaling from the target SN to the MN may include a list of the updated execution conditions for the CPCSA/CPASA Candidate Configurations. If the measurement event list is preconfigured to the UE and is known to the target SN, the inter-node signaling from the target SN to the MN may include a list of sequences including a CPCSA/CPASA Candidate Configuration ID and a measurement event ID.

In some implementations, for the SN-initiated inter-SN CPCSA, the target SN may generate the updated execution conditions for the subsequent CPC every time upon receiving the RRC signaling from the UE. After the MN and target SN update the UE's information and the indication of keeping/suspending/releasing of each CPCSA Candidate Configuration and/or CPCSA Candidate Configuration, the MN or target SN may configure the UE with the updated CPCSA configuration through the RRC signaling or the MAC CE signaling. The information of the updated CPCSA configuration may include the indication (message) of keeping/suspending/releasing and/or the CPCSA configuration update message.

The indication of keeping/suspending/releasing of the CPCSA Candidate Configuration(s) and/or the CPCSA Candidate Configuration(s) may include a single message. For example, the indication may include 2N bits for N CPCSA Candidate Configurations, where N is a positive integer. Each pair of bits may be explicitly or implicitly mapped to a CPCSA Candidate Configuration: for example, the codeword ‘00’ may indicate that the CPCSA Candidate Configuration is kept, the codeword ‘01’ may indicate that the CPCSA Candidate Configuration is suspended, the codeword ‘10’ may indicate that the CPCSA Candidate Configuration is released, and the codeword ‘11] may be reserved. It should be noted that the codewords and their representing operations (e.g., keeping/suspending/releasing) may vary up to practical implementations. Additionally or alternatively, the indication may include a list of N ENUMERATED values for N CPCSA Candidate Configurations, where N is a positive integer. The ENUMERATED value may be one of the options in the set {‘keep’, ‘suspend’, ‘release’} or {‘keep’, ‘suspend’, ‘release’, spare}, and each ENUMERATED value may correspond to a CPCSA Candidate Configuration or a spare meaning for future use. For example, the option ‘keep’ may indicate that the CPCSA Candidate Configuration is kept, the option ‘suspend’ may indicate that the CPCSA Candidate Configuration is suspended, and the option ‘release’ may indicate that the CPCSA Candidate Configuration is released.

The indication of keeping/suspending/releasing of the CPCSA Candidate Configuration(s) and/or the CPCSA Candidate Configuration(s) may include a list of CPCSA IDs to be released and/or a list of CPCSA IDs to be suspended.

In some implementations, the indication of keeping/suspending/releasing of the CPCSA Candidate Configuration(s) and/or the CPCSA Candidate Configuration(s) may include a first message of a suspension indication and a second message of a release indication. The first message may include a list of CPCSA IDs to be suspended (e.g., the CPCSA Candidate Configurations corresponding to the CPCSA IDs in the list are indicated to be suspended). Additionally or alternatively, the first message may include N bits, each bit corresponding to one of N CPCSA Candidate Configurations, where N is a positive integer. For each bit, the corresponding CPCSA Candidate Configuration may be suspended if the bit is 0 and activated if the bit is 1, or may be suspended if the bit is 1 and activated if the bit is 0. The second message may include a list of CPCSA IDs to be released. Additionally or alternatively, the second message may include N bits, each bit corresponding to one of N CPCSA Candidate Configurations, where N is a positive integer. For each bit, the corresponding CPCSA Candidate Configuration may be released if the bit is 0 and kept if the bit is 1, or may be released if the bit is 1 and kept if the bit is 0.

In some implementations, the CPCSA configuration update message may include multiple updated CPCSA Candidate Configurations.

In some implementations, the CPCSA configuration update message may include multiple updated delta CPCSA Candidate Configurations. A UE may combine the delta CPCSA Candidate Configuration with the preconfigured or stored reference CPCSA Candidate Configuration to obtain a complete CPCSA Candidate Configuration. A delta CPCSA Candidate Configuration may include an execution condition, and/or a delta conditional MCG configuration, and/or a delta conditional SCG configuration.

In some implementations, the execution condition IEs in the CPCSA Candidate Configuration may include the measurement events and the corresponding event parameters. Additionally or alternatively, the execution condition IEs in the CPCSA Candidate Configuration may include the preconfigured measurement event IDs. In some implementations, the MN may configure the UE with the execution conditions (e.g., the execution condition IEs) via the separate signaling from the MCG/SCG configuration and/or the release/suspension indication.

In some implementations, upon receiving the updated CPCSA configuration, a UE may determine whether to keep, suspend, or release certain CPCSA Candidate Configurations, and the UE may compare the ID of each updated CPCSA Candidate Configuration with the ID of each stored CPCSA Candidate Configuration.

In some implementations, the indication of keeping/suspending/releasing the CPCSA Candidate Configuration(s) may include a single message, where the message may include 2N bits for N stored CPCSA Candidate Configurations. The UE may perform the keeping/suspending/releasing operation on each of the stored CPCSA Candidate Configurations based on the 2-bit codeword indicated in the message. For example, for a CPCSA Candidate Configuration, if a codeword ‘00’ is indicated, the UE may keep and activate the CPCSA Candidate Configuration; if a codeword ‘01’ is indicated, the UE may keep and suspend the CPCSA Candidate Configuration; if a codeword ‘10’ is indicated, the UE may release the CPCSA Candidate Configuration. It should be noted that the mapping between the codeword and the operation may vary up to practical implementations. For each CPCSA Candidate Configuration, a UE may set the suspension field to ‘Activated’ if the CPCSA Candidate Configuration is configured to be kept and activated. The UE may set the suspension field to ‘Suspended’ if the CPCSA Candidate Configuration is configured to be kept and suspended.

In some implementations, the indication of keeping/suspending/releasing the CPCSA Candidate Configuration(s) may include a list of N ENUMERATED values for N CPCSA Candidate Configurations, where N is a positive integer. The UE may perform the keeping/suspending/releasing on the CPCSA Candidate Configurations based on the ENUERATED values. The ENUMERATED value may be one of the options in the set {‘keep’, ‘suspend’, ‘release’} or {‘keep’, ‘suspend’, ‘release’, spare}, and each ENUMERATED value may correspond to a CPCSA Candidate Configuration or a spare meaning for future use. For example, the UE may keep and activate a CPCSA Candidate Configuration if its corresponding ENUMERATED value is ‘keep’; the UE may keep and suspend a CPCSA Candidate Configuration if its corresponding ENUMERATED value is ‘suspend’; the UE may release a CPCSA Candidate Configuration if its corresponding ENUMERATED value is ‘release’.

In some implementations, the indication of keeping/suspending/releasing the CPCSA Candidate Configuration(s) may include a single message, where the message may include a list of CPCSA Candidate Configuration IDs. The UE may release the stored CPCSA Candidate Configurations corresponding to the IDs in the list, and keep the stored CPCSA Candidate Configurations corresponding to the IDs not present in the list.

In some implementations, the indication of keeping/suspending/releasing the CPCSA Candidate Configuration(s) may include a single message, where the message may include a list of CPCSA Candidate Configuration IDs. The UE may set the suspension field of the stored CPCSA Candidate Configurations corresponding to the IDs in the list to ‘Suspended’, and set the suspension field of the stored CPCSA Candidate Configurations corresponding to the IDs not present in the list to ‘Activated’.

In some implementations, the indication of keeping/suspending/releasing the CPCSA Candidate Configuration(s) may include a first message of a suspension indication and a second message of a release indication.

The first message may include a list of CPCSA Candidate Configuration IDs. In this case, the UE may set the suspension field of the CPCSA Candidate Configurations corresponding to the IDs in the list to ‘Suspended’ and set the suspension filed of the CPCSA Candidate Configurations corresponding to the IDs not present in the list to ‘Activated’. Additionally or alternatively, the first message may include N bits, each bit corresponding to one of N CPCSA Candidate Configurations, where N is a positive integer. For each CPCSA Candidate Configuration, the UE may set the corresponding suspension field to ‘Suspended’ if the corresponding bit is 0 and set the corresponding suspension field to ‘Activated’ if the corresponding bit is 1. Conversely, the suspension field may be set to ‘Suspended’ if the corresponding bit is 1 and to ‘Activated’ if the corresponding bit is 0. The second message may include a list of CPCSA Candidate Configuration IDs. The UE may release the CPCSA Candidate Configurations corresponding to the IDs in the list. Additionally or alternatively, the second message may include N bits for N CPCSA Candidate Configurations, where N is a positive integer. For each CPCSA Candidate Configuration, the UE may release it if the corresponding bit is set to a specific value (e.g., 0 or 1).

In some implementations, if the ID of an updated CPCSA Candidate Configuration matches the ID of a stored CPCSA Candidate Configuration, and the updated CPCSA Candidate Configuration is a complete configuration. In this case, the UE may release the stored CPCSA Candidate Configuration and store the updated CPCSA Candidate Configuration.

In some implementations, if the ID of an updated CPCSA Candidate Configuration matches the ID of a stored CPCSA Candidate Configuration, and the updated CPCSA Candidate Configuration is a delta configuration, the UE may combine the delta CPCSA Candidate Configuration with the preconfigured reference CPCSA Candidate Configuration to obtain a complete CPCSA Candidate Configuration. The UE may then release the stored CPCSA Candidate Configuration and store the obtained complete CPCSA Candidate Configuration.

In some implementations, if the ID of an updated CPCSA Candidate Configuration matches the ID of a stored CPCSA Candidate Configuration, and the updated CPCSA Candidate Configuration is a delta configuration, the UE may combine the delta CPCSA Candidate Configuration with the stored CPCSA Candidate Configuration to obtain a complete CPCSA Candidate Configuration. The UE may then release the stored CPCSA Candidate Configuration and store the obtained complete CPCSA Candidate Configuration.

In some implementations, if the ID of an updated CPCSA Candidate Configuration does not match the ID of any stored CPCSA Candidate Configurations, and the updated CPCSA Candidate Configuration is a complete configuration, the UE may store the CPCSA Candidate Configuration.

In some implementations, if the ID of an updated CPCSA Candidate Configuration does not match the ID of any stored CPCSA Candidate Configurations, and the updated CPCSA Candidate Configuration is a delta configuration, the UE may combine the delta CPCSA Candidate Configuration with the preconfigured reference CPCSA Candidate Configuration to obtain a complete CPCSA Candidate Configuration. The UE may then store the obtained complete CPCSA Candidate Configuration.

In some implementations, if the UE receives the execution condition IEs that include the measurement events and the corresponding parameters, the UE may release the measurement events stored in the CPCSA Candidate Configurations and apply the updated measurement events to the corresponding CPCSA Candidate Configurations.

In some implementations, if the UE receives the execution condition IE that includes a list of sequences including a measurement event ID and a CPCSA Candidate Configuration ID, and if the measurement event list is preconfigured, the UE may release the measurement events stored in the CPCSA Candidate Configuration and apply the stored measurement event (corresponding to the measurement event ID) to the CPCSA Candidate Configuration corresponding to the CPCSA Candidate Configuration ID.

In some implementations, after updating the stored CPCSA configuration, the UE may apply at least part of the CPCSA configuration and start performing evaluation on certain PSCells associated with the CPCSA Candidate Configurations.

In some implementations, for each CPCSA Candidate Configuration whose corresponding suspension field is set to ‘Suspended’, the UE may keep storing (e.g., maintaining or retaining) the CPCSA Candidate Configuration and may suspend the evaluation on the associated PSCell.

In some implementations, for each CPCSA Candidate Configuration whose corresponding suspension field is set to ‘Activated’, the UE may apply the PSCell ID and the execution condition(s), and the UE may start to evaluate the associated candidate target PSCell. The UE may keep storing the conditional configuration.

In some implementations, if the UE is configured with multiple SA counters, the source node may configure the UE to decrease (the value of) the SA counter corresponding to the executed CPCSA/CPASA Candidate Configuration by 1 upon the CPA/CPC execution.

In some implementations, if configured, upon the UE transmitting the RRC message containing the CPCSA/CPASA Candidate Configuration ID, the UE may decrease (the value of) the SA counter corresponding to the executed CPCSA/CPASA Candidate Configuration by 1.

In some implementations, the source node may decrease (the value of) the corresponding SA counter associated with the UE by 1 upon receiving the RRC message containing the CPCSA/CPASA Candidate Configuration ID sent by the UE.

In some implementations, if the UE is configured with multiple SA counters, the source node may configure the UE to decrease (the value of) all SA counters by 1 upon the CPA/CPC execution.

In some implementations, if configured, the UE may decrease (the value of) all SA counters by 1 upon transmitting the RRC message containing the CPCSA/CPASA Candidate Configuration ID.

In some implementations, the source node may decrease (the value of) all SA counters associated with the UE by 1 upon receiving the RRC message containing the CPCSA/CPASA Candidate Configuration ID sent by the UE.

In some implementations, if the UE is configured with a single SA counter associated with all the CPASA/CPCSA Candidate Configurations, the UE may decrease (the value of) the SA counter by 1 upon transmitting the RRC message containing CPCSA/CPASA Candidate Configuration ID.

In some implementations, the source node may decrease (the value of) the SA counter associated with the UE by 1 upon receiving the RRC message containing the CPCSA/CPASA Candidate Configuration ID sent by the UE.

In some implementations, upon the CPA execution, the UE may turn (or convert) the stored CPASA Candidate Configurations to CPCSA Candidate Configurations and keep storing them.

In some implementations, the source node may configure a parameter associated with a decreasing method (e.g., by decreasing (the value of) a single SA counter or multiple SA counters) to the UE via RRC signaling.

In some implementations, the parameter associated with the decreasing method may take the ENUMERATED value. For example, the method may take one of the values in {‘DECREASE_ALL’, ‘DECREASE_SINGLE’}. The parameter associated with the decreasing method may be configured in a separate RRC message. The parameter associated with the decreasing method may be configured in the RRC message containing the CPASA/CPCSA Candidate Configurations.

In some implementations, if the UE is configured with multiple SA counters, when the UE decreases (the values of) certain SA counters to 0, the UE may release the CPASA/CPCSA Candidate Configurations corresponding to the SA counters which are decreased to 0.

In some implementations, when the source node decreases (the values of) certain SA counters to 0, the source node may release the CPASA/CPCSA Candidate Configurations corresponding to the SA counters which are decreased to 0.

In some implementations, if the UE is configured with a single SA counter associated with all CPASA/CPCSA Candidate Configurations, when the UE decreases (the values of) the SA counter to 0, the UE may release all of the stored CPASA/CPCSA Candidate Configurations.

In some implementations, when the source node decreases the SA counter associated with the UE to 0, the source node may release all of the CPASA/CPCSA Candidate Configurations associated with the UE.

In some implementations, if the MN maintains the SA counter, upon the release of the CPASA/CPCSA Candidate Configurations, the MN may initiate the SN release procedure to all candidate target SNs whose CPASA/CPCSA Candidate Configurations are to be released.

In some implementations, during the SN release procedure, the associated candidate target SNs may release the prepared PSCells and the SCG configurations for the UE. The UE may not be involved in the release procedure, and there may be no signaling exchange between any network node and the UE.

In some implementations, if the source SN maintains the SA counter, upon the release of the CPASA/CPCSA Candidate Configurations, the source SN may release the prepared PSCells and SCG configurations corresponding to the CPASA/CPCSA Candidate Configurations to be released. There may be no signaling exchange between any network node and the UE (e.g., the network may not inform the UE of the release).

Configuration of the CPAC with the SCG Selective Activation During the Evaluation

For a UE configured with the CPASA or CPCSA Candidate Configurations, the network may reconfigure the CPASA or CPCSA Candidate Configurations due to the change of certain network conditions. The MN and the candidate target SN may determine whether to modify, suspend, or release the CPASA/CPCSA Candidate Configuration for the UE. It should be noted that the configuration during the evaluation may also be applied for other cases, e.g., the UE configured with the CPA and/or CPC without the SCG selective activation.

In some implementations, the MN may update the CPCSA/CPASA Candidate Configuration via the RRC signaling to the UE. The updated configuration (e.g., the updated CPCSA/CPASA Candidate Configuration) may include at least one of the following: an ID that identifies the configuration as a CPCSA/CPASA Candidate Configuration, an indication (e.g., a particular IE) that indicates whether the updated SCG configuration is a complete or a delta configuration, an updated MCG configuration IE, an updated SCG configuration IE, and the execution condition IE that indicates the updated execution condition. It should be noted that the SCG configuration may be a complete or a delta configuration.

In some implementations, the MN may inform the UE of the suspension or release of a CPCSA/CPASA Candidate Configuration via the RRC signaling and/or the MAC CE signaling.

The RRC signaling may include 2N bits for N CPCSA/CPASA Candidate Configurations, where N is a positive integer. Each pair of bits may be explicitly or implicitly mapped to a CPCSA/CPASA Candidate Configuration: for example, the codeword ‘00’ may indicate that the CPCSA/CPASA Candidate Configuration is kept, the codeword ‘01’ may indicate that the CPCSA/CPASA Candidate Configuration is suspended, the codeword ‘10’ may indicate that the CPCSA/CPASA Candidate Configuration is released, and the codeword ‘11’ may be reserved. It should be noted that the codewords and their representing operations (e.g., keeping/suspending/releasing) may vary up to practical implementations.

The indication (e.g., the indication of keeping/suspending/releasing of the CPCSA Candidate Configuration(s)) may include a list of N ENUMERATED values for N CPCSA Candidate Configurations, where N is a positive integer. The ENUMERATED value may be one of the options in the set {‘keep’, ‘suspend’, ‘release’} or {‘keep’, ‘suspend’, ‘release’, spare}, and each ENUMERATED value may correspond to a CPCSA Candidate Configuration or a spare meaning for future use. For example, the option ‘keep’ may indicate that the CPCSA Candidate Configuration is kept, the option ‘suspend’ may indicate that the CPCSA Candidate Configuration is suspended, and the option ‘release’ may indicate that the CPCSA Candidate Configuration is released.

The RRC signaling may include a list of CPCSA/CPASA IDs to be suspended (e.g., the CPCSA/CPASA Candidate Configurations corresponding to the CPCSA/CPASA IDs present in the list are indicated to be suspended).

The RRC signaling may include N bits for N CPCSA/CPASA Candidate Configurations, where N is a positive integer. For each bit, the corresponding CPCSA/CPASA Candidate Configuration may be suspended if the bit is 0 and activated if the bit is 1, or may be suspended if the bit is 1 and activated if the bit is 0.

The RRC signaling may include a list of CPCSA/CPASA IDs to be released (e.g., the CPCSA/CPASA Candidate Configurations corresponding to the CPCSA/CPASA IDs present in the list are indicated to be released).

The RRC signaling may include N bits for N CPCSA/CPASA Candidate Configurations. For each bit, the corresponding CPCSA/CPASA Candidate Configuration may be released if the bit is 0 and kept if the bit is 1, or may be released if the bit is 1 and kept if the bit is 0.

In some implementations, the execution condition IEs in the CPCSA/CPASA Candidate Configuration may include the measurement events and the corresponding event parameters.

In some implementations, the execution condition IEs in the CPCSA/CPASA Candidate Configuration may include the preconfigured measurement event IDs.

In some implementations, the MN may configure the UE with the execution conditions (e.g., the execution condition IEs) via the signaling separate from the MCG/SCG configuration and/or the release/suspension indication.

In some implementations, upon receiving the updated configuration, the UE may update the stored list of CPCSA/CPASA Candidate Configurations. The UE may check the received CPCSA/CPASA Candidate Configuration ID with the stored CPCSA/CPASA Candidate Configuration IDs.

If the UE receives a CPCSA/CPASA Candidate Configuration ID that does not match any stored CPCSA/CPASA Candidate Configuration IDs at the UE, the UE may store and apply the received CPCSA/CPASA Candidate Configuration. For example, the UE may directly apply the received CPCSA/CPASA Candidate Configuration. Additionally or alternately, the UE may combine the received CPCSA/CPASA Candidate Configuration with a preconfigured reference configuration to obtain a complete CPCSA/CPASA Candidate Configuration. The UE may then store and apply the obtained CPCSA/CPASA Candidate Configuration.

If the UE receives a CPCSA/CPASA Candidate Configuration ID that matches one of the stored CPCSA/CPASA Candidate Configuration IDs, the UE may modify the corresponding stored CPCSA/CPASA Candidate Configuration. For example, if the updated configuration received from the source node indicates that the updated SCG configuration is a complete configuration, the UE may release the stored SCG configuration of the corresponding CPCSA/CPASA Candidate Configuration, and the UE may store and apply the received updated SCG configuration to the corresponding CPCSA/CPASA Candidate Configuration. If the updated configuration received from the source node indicates that the updated SCG configuration is a delta configuration, and if there is no preconfigured reference SCG configuration at the UE, the UE may combine the received CPCSA/CPASA Candidate Configuration with the currently stored corresponding CPCSA/CPASA Candidate Configuration to obtain a complete CPCSA/CPASA Candidate Configuration, and the UE may store and apply the obtained CPCSA/CPASA Candidate Configuration. Additionally or alternatively, if the updated configuration received from the source node indicates that the updated SCG configuration is a delta configuration, and if the UE has already configured with a preconfigured reference SCG configuration, the UE may combine the received CPCSA/CPASA Candidate Configuration with the preconfigured reference configuration to obtain a complete CPCSA/CPASA Candidate Configuration, and the UE may store and apply the obtained CPCSA/CPASA Candidate Configuration.

In some implementations, the UE may set the suspension field of a CPCSA/CPASA Candidate Configuration to ‘Suspended’ and suspend the evaluation on the associated PSCell for the CPCSA/CPASA Candidate Configurations which are configured to be suspended.

In some implementations, the UE may release the stored CPCSA/CPASA Candidate Configurations which are configured to be released.

In some implementations, if the received execution condition IEs include the measurement events and the corresponding parameters, the UE may release the measurement events stored in the CPCSA/CPASA Candidate Configurations and apply the updated measurement events to the corresponding CPCSA/CPASA Candidate Configurations.

In some implementations, if the received execution condition IE includes a list of sequences including a measurement event ID and a CPCSA/CPASA Candidate Configuration ID, and if the measurement event list is preconfigured, the UE may release the measurement events stored in the CPCSA/CPASA Candidate Configuration and apply the stored measurement event corresponding to the measurement event ID to the CPCSA/CPASA Candidate Configuration corresponding to the CPCSA/CPASA Candidate Configuration ID.

In some implementations, for a UE configured with CPASA/CPCSA Candidate Configurations, the network may indicate to the UE to reset/update the associated SA counter(s). If at least one of the SA counters is reset/updated, the source node may configure the UE with the reset/update indication via RRC signalling or MAC CE. The RRC signalling or MAC CE for reset/update indication may comprise a reset indication and an update indication.

In some implementations, if a UE is configured with multiple SA counters for different CPASA/CPCSA Candidate Configurations, a reset indication may comprise N bits corresponding to the N CPASA/CPCSA Candidate Configurations, and each bit may indicate whether to reset the SA counter of the corresponding CPASA/CPCSA Candidate Configuration. For example, in some implementations, upon the reception of the reset indication, the UE may reset the SA counter of a CPASA/CPCSA Candidate Configuration to its stored maximum value if the corresponding bit is 1, and may keep the SA counter as the current value if the corresponding bit is 0.

In some implementations, if a UE is configured with multiple SA counters for different CPASA/CPCSA Candidate Configurations, a reset indication may comprise a list of CPASA/CPCSA Candidate Configuration IDs. In some implementations, upon the reception of the reset indication, the UE may reset the SA counter of a CPASA/CPCSA Candidate Configuration to its stored maximum value if the ID appears in the list.

In some implementations, if a UE is configured with a single SA counter for all CPASA/CPCSA Candidate Configurations, a reset indication may comprise a bit indicating whether to reset the SA counter. For example, in some implementations, upon the reception of the reset indication, the UE may reset the SA counter to its stored maximum value if the bit is 1, and may keep the SA counter as the current value if the corresponding bit is 0.

In some implementations, if a UE is configured with multiple SA counters for different CPASA/CPCSA Candidate Configurations, an update indication may comprise a list of sequences comprising a CPASA/CPCSA Candidate Configuration ID and an updated SA counter value. In some implementations, upon the reception of the update indication, the UE may update the SA counters of the CPASA/CPCSA Candidate Configurations corresponding to the IDs to their updated values. In some implementations, upon the reception of the update indication, the UE may update the maximum values of the SA counters of the CPASA/CPCSA Candidate Configurations corresponding to the IDs to their updated values.

### Unsynchronized SA Counter

It is possible that the value of the SA counter maintained by the UE is not synchronized with that maintained by the source node. Two cases of unsynchronization have been identified, and corresponding solutions are provided.

In some implementations, the SA counter maintained by the UE (e.g., by the MAC layer of the UE, by the RRC layer of the UE) may be smaller than that maintained by the source node. It is possible that a UE releases some CPCSA Candidate Configuration while the source node does not. In this case, if the source node configures the reset/update indication of the SA counter, the UE may not comply with the configuration.

The UE may send an RRC message (e.g., an RRC reestablishment request, which is also referred to as an RRCReestablishmentRequest message in the present disclosure) to the source node to indicate that the SA counter has expired. Upon receiving the RRC message sent by the UE, the source node may release the corresponding expired SA counter and the associated CPCSA Candidate Configurations, and the source node may inform the associated candidate target SNs to release the PSCells and the SCG configurations. The indication of the SA counter expiry in the RRC message may have the ENUMERATED format. If the UE cannot comply with the configuration sent from the source node, and/or if the UE has released some CPCSA Candidate Configuration but receives the reset/update indication of the SA counter, the UE may transmit an RRC message (e.g., an RRCReestablishmentRequest message or an RRC message for informing the failure) to the source node. For example, the RRC message may include the failure cause. The failure cause may be in the ENUMERATED format, where the values in the ENUMERATED format may include ‘unsync’ and/or ‘incompliance’ to indicate the reason/cause of the failure.

In some implementations, the SA counter maintained by the UE may be larger than that maintained by the source node. The network releases certain CPCSA Candidate Configuration while the UE does not. In this case, a UE may execute the CPC towards a candidate PSCell which is released by the source node.

The UE may send an RRC message (e.g., an RRC reconfiguration complete message, which is also referred to as the RRCReconfigurationComplete message in the present disclosure) containing the ID of the executed CPCSA Candidate Configuration. Upon receiving the RRC message, the source node may identify the unsynchronized SA counter problem.

Additionally or alternatively, upon receiving the RRC message containing the ID of the executed CPCSA Candidate Configuration which has been released at the network side, the source node may send an RRC message to the UE to inform the unsynchronized SA counter problem. The RRC message may contain an indication field for unsynchronized SA counter problem. The indication field may have the ENUMERATED format. For example, the indication field may be set to the value {‘TRUE’}. If a UE is configured with multiple SA counters, the RRC message may contain the current value of each SA counter. The current value of each SA counter may take the format of a list of sequences including a CPCSA Candidate Configuration ID and an SA counter value.

In some implementations, upon receiving the RRC message containing the ID of the executed CPCSA Candidate Configuration which has been released at the network side, the source node may send an RRC message to the UE to release the CPCSA Candidate Configuration in the UE.

In some implementations, upon receiving the RRC message indicating the unsynchronized SA counter problem from the source node, the UE may stop executing the CPC and release the corresponding CPCSA Candidate Configuration. If the received RRC message contains the current value of each SA counter, the UE may update the counter values.

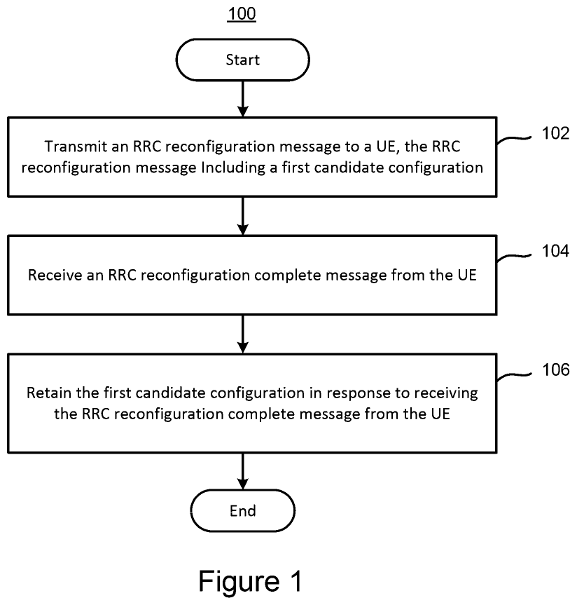

FIG. 1 is a flowchart of a method/process 100 for executing a conditional PSCell addition and/or change with a selective activation (e.g., a CPASA and/or a CPCSA) with a UE, according to an example implementation of the present disclosure. It should be noted that although actions 102, 104, and 106 are illustrated as separate actions, represented as independent blocks, in FIG. 1, these separately illustrated actions should not be construed as necessarily order-dependent. The order in which the actions are performed in FIG. 1 is not intended to be construed as a limitation, and any number of the disclosed blocks may be combined in any order to implement the method, or an alternative method. Moreover, each of actions 102, 104, and 106 may be performed independently of other actions and may be omitted in some implementations of the present disclosure. The process 100 may be performed by a BS (e.g., an MN).

In action 102, the process 100 may start by transmitting an RRC reconfiguration message to a UE. The RRC reconfiguration message may include a first candidate configuration (e.g., a CPCSA candidate configuration and/or a CPASA candidate configuration). In some implementations, the RRC signaling that includes the CPCSA/CPASA candidate configuration(s), as described elsewhere in this disclosure, may also serve as the RRC reconfiguration message in this action.

In action 104, the BS may receive an RRC reconfiguration complete message from the UE. In some implementations, the RRC signaling received by the BS in response to the completion of the CPCSA, as described elsewhere in this disclosure, may also serve as the RRC reconfiguration complete message in this action.

In action 106, the BS may retain (or keep) the first candidate configuration in response to receiving the RRC reconfiguration complete message from the UE.

The first candidate configuration may include a first indication (e.g., an indication of the CPCSA/CPASA), a first candidate target PSCell identity, at most two first execution conditions, and one or more first conditional configurations associated with the at most two first execution conditions. The first indication may indicate that the first candidate configuration (including the first indication) should be retained after the CPC/CPA completes and/or indicate that the first candidate configuration is a candidate configuration of the CPASA (which is also referred to as “CPASA Candidate Configuration” in the present disclosure) or a candidate configuration of the CPCSA (which is also referred to as “CPCSA Candidate Configuration” in the present disclosure). For example, if the UE receives a configuration from the BS that includes the first indication, the UE may recognize the received configuration as a CPCSA Candidate Configuration or a CPASA Candidate Configuration and does not release the configuration after the CPC/CPA completes. The candidate target PSCell identity may indicate a candidate target PSCell for the UE in the CPCSA and/or the CPASA. For example, the UE may switch to one of the candidate target PSCells in the CPCSA or add one of the candidate target PSCells as a PSCell in the CPASA. The first execution conditions are provided to the UE to enable it to determine/evaluate whether to execute a CPCSA or a CPASA based on the associated first conditional configuration(s). The first conditional configuration(s) may include the RRC configuration that the UE applies to establish connections to the MCG and/or the target SCG, and/or for the data transmission towards the MCG and/or the target SCG.

In some implementations, the RRC reconfiguration message may further include a second candidate configuration (e.g., a CPC candidate configuration). The second candidate configuration may include a second candidate target PSCell identity, at most two second execution conditions, and one or more second conditional configurations associated with the at most two second execution conditions. The second execution conditions are provided to the UE to enable it to determine/evaluate whether to execute a CPC based on the associated second conditional configurations. The second conditional configuration(s) may include the RRC configuration that the UE applies to establish connections to the MCG and/or the target SCG, and/or for the data transmission towards the MCG and/or the target SCG. Unlike the first candidate configuration, the second candidate configurations may be devoid of the first indication. Therefore, the UE may not consider the received second candidate configuration as a CPCSA/CPASA configuration. That is, the second candidate configuration, by not including the first indication, may not be designated as a candidate configuration for the CPASA or the CPCSA for the UE. For example, once the UE determines that the first indication is absent from the received second candidate configuration, the UE does not consider the second candidate configuration as a CPCSA Candidate Configuration or a CPASA Candidate Configuration. Instead, the UE may consider the second candidate configuration as a CPC candidate configuration.

In some implementations, the process 100 may further include releasing the second candidate configuration in response to receiving the RRC reconfiguration complete message from the UE. As described above, unlike the treatment of the second candidate configuration, the BS may retain the first candidate configuration in response to receiving the RRC reconfiguration complete message. This differentiation in handling ensures that the second candidate configuration is released after the PSCell change or addition is complete, whereas the first candidate configuration is retained by the BS for ongoing or future use.

In some implementations, the RRC reconfiguration complete message may include a second indication that indicates which of the one or more first conditional configurations the UE has selected to use/apply for executing the CPASA or the CPCSA.

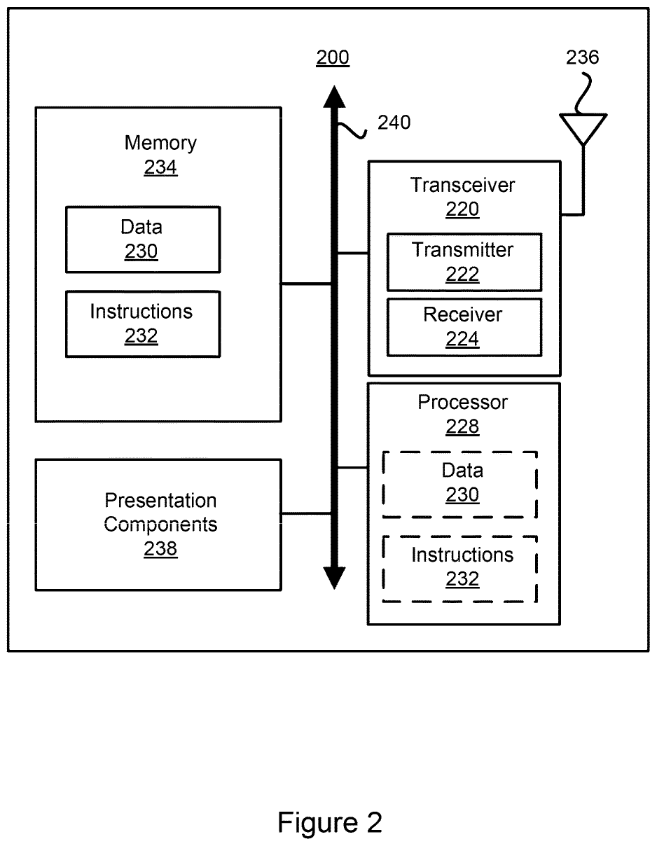

FIG. 2 is a block diagram illustrating a node 200 for wireless communications, in accordance with various aspects of the present disclosure. As illustrated in FIG. 2, node 200 may include transceiver 220, processor 228, memory 234, one or more presentation components 238, and at least one antenna 236. Node 200 may also include a radio frequency (RF) spectrum band module, a BS communications module, a network communications module, and a system communications management module, Input/Output (I/O) ports, I/O components, and a power supply (not illustrated in FIG. 2).

Each of the components may directly or indirectly communicate with each other over one or more buses 240. Node 200 may be a UE or a BS that performs various functions disclosed with reference to FIG. 1.

Transceiver 220 has transmitter 222 (e.g., transmitting/transmission circuitry) and receiver 224 (e.g., receiving/reception circuitry) and may be configured to transmit and/or receive time and/or frequency resource partitioning information. Transceiver 220 may be configured to transmit in different types of subframes and slots including, but not limited to, usable, non-usable, and flexibly usable subframes and slot formats. Transceiver 220 may be configured to receive data and control channels.

Node 200 may include a variety of computer-readable media. Computer-readable media may be any available media that may be accessed by node 200 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

Memory 234 may include computer-storage media in the form of volatile and/or non-volatile memory. Memory 234 may be removable, non-removable, or a combination thereof. Example memory may include solid-state memory, hard drives, optical-disc drives, etc. As illustrated in FIG. 2, memory 234 may store a computer-readable and/or computer-executable instructions 232 (e.g., software codes) that are configured to, when executed, cause processor 228 to perform various functions disclosed herein, for example, with reference to FIG. 1. Alternatively, instructions 232 may not be directly executable by processor 228 but may be configured to cause node 200 (e.g., when compiled and executed) to perform various functions disclosed herein.

Processor 228 (e.g., having processing circuitry) may include an intelligent hardware device, e.g., a Central Processing Unit (CPU), a microcontroller, an ASIC, etc. Processor 228 may include memory. Processor 228 may process data 230 and instructions 232 received from memory 234, and information transmitted and received via transceiver 220, the baseband communications module, and/or the network communications module. Processor 228 may also process information to send to transceiver 220 for transmission via antenna 236 to the network communications module for transmission to a CN.

One or more presentation components 238 may present data indications to a person or another device. Examples of presentation components 238 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a Base Station (BS) for executing a Conditional Primary Secondary Cell (PSCell) Addition and/or Change with a Selective Activation, the method comprising:
transmitting a Radio Resource Control (RRC) reconfiguration message to a User Equipment (UE), the RRC reconfiguration message comprising a first candidate configuration;
receiving an RRC reconfiguration complete message from the UE; and
retaining the first candidate configuration in response to receiving the RRC reconfiguration complete message from the UE,
wherein the first candidate configuration comprises:
a first indication that indicates the first candidate configuration, as a candidate configuration of the Conditional PSCell Addition with the Selective Activation (CPASA) or, as a candidate configuration of the Conditional PSCell Change with the Selective Activation (CPCSA),
a first candidate target PSCell identity,
a first candidate target PSCell identity;
at most two first execution conditions, and
one or more first conditional configurations associated with the at most two first execution conditions.

2. The method of claim 1, wherein the RRC reconfiguration message further comprises a second candidate configuration that comprises:
a second candidate target PSCell identity,
at most two second execution conditions, and
one or more second conditional configurations associated with the at most two second execution conditions,
wherein the second candidate configuration, by not comprising the first indication, is not designated as the candidate configuration for the CPASA or the CPCSA for the UE.

3. The method of claim 2, further comprising:
releasing the second candidate configuration in response to receiving the RRC reconfiguration complete message from the UE.

4. The method of claim 3, wherein the RRC reconfiguration complete message comprises a second indication that indicates which of the one or more first conditional configurations the UE has selected to use for executing the CPASA or the CPCSA.

5. A Base Station (BS) for executing a Conditional Primary Secondary Cell (PSCell) Addition and/or Change with a Selective Activation, the BS comprising:
at least one processor; and
at least one non-transitory computer-readable medium coupled to the at least one processor and storing one or more computer-executable instructions that, when executed by the at least one processor, cause the BS to:
transmit a Radio Resource Control (RRC) reconfiguration message to a User Equipment (UE), the RRC reconfiguration message comprising a first candidate configuration;
receive an RRC reconfiguration complete message from the UE; and
retain the first candidate configuration in response to receiving the RRC reconfiguration complete message from the UE,
wherein the first candidate configuration comprises:
a first indication that indicates the first candidate configuration, as a candidate configuration of the Conditional PSCell Addition with the Selective Activation (CPASA) or, as a candidate configuration of the Conditional PSCell Change with the Selective Activation (CPCSA),
a first candidate target PSCell identity,
at most two first execution conditions, and
one or more first conditional configurations associated with the at most two first execution conditions.

6. The BS of claim 5, wherein the RRC reconfiguration message further comprises a second candidate configuration that comprises:
a second candidate target PSCell identity,
at most two second execution conditions, and
one or more second conditional configurations associated with the at most two second execution conditions,
wherein the second candidate configuration, by not comprising the first indication, is not designated as the candidate configuration for the CPASA or the CPCSA for the UE.

7. The BS of claim 6, wherein the one or more computer-executable instructions, when executed by the at least one processor, further cause the BS to:
release the second candidate configuration in response to receiving the RRC reconfiguration complete message from the UE.

8. The BS of claim 7, wherein the RRC reconfiguration complete message comprises a second indication that indicates which of the one or more first conditional configurations the UE has selected to use for executing the CPASA or the CPCSA.
